(19) United States
(12) Patent Application Publication
(10) Pub. No.: US 2024/0320761 A1
(43) Pub. Date: Sep. 26, 2024

(54) PROGRAM, INFORMATION PROCESSING DEVICE, AND INFORMATION PROCESSING METHOD

(71) Applicant: Sony Group Corporation, Tokyo (JP)

(72) Inventors: Godai Suzuki, Kanagawa (JP); Kosuke Katano, Tokyo (JP); Masatoshi Funabashi, Tokyo (JP)

(73) Assignee: Sony Group Corporation, Tokyo (JP)

(21) Appl. No.: 18/577,772

(22) PCT Filed: Feb. 22, 2022
(86) PCT No.: PCT/JP2022/007143

§ 371 Date: Jan. 9, 2024

(30) Foreign Application Priority Data
Jul. 20, 2021 (JP) 2021-119648

(51) Int. Cl. G06Q 50/02

(52) U.S. Cl. CPC G06Q 50/02

(57) ABSTRACT

The present technology relates to a program, an information processing device, and an information processing method capable of providing a combination of biological species appropriate for constructing a target ecosystem.

For each of a plurality of combinations of biological species selected from a plurality of biological species, an interaction network representing an interaction between a main biological species and a sub-biological species is constructed using the main biological species that is a biological species constituting the combination and the sub-biological species that is another biological species that causes an interaction with the main biological species as nodes, and a presentation combination that is a combination of biological species to be presented is decided according to evaluation of the interaction network obtained by evaluating the interaction network by an evaluation method regarding an ecosystem. The present technology can be applied to, for example, an ecosystem support system that provides a combination of biological species appropriate for an ecosystem.

### TECHNICAL FIELD

The present technology relates to a program, an information processing device, and an information processing method, and particularly relates to, for example, a program, an information processing device, and an information processing method capable of providing a combination of biological species appropriate to a target ecosystem.

### BACKGROUND ART

As a technology for extending an ecosystem function by operation of biological diversity, for example, there is Synecoculture (registered trademark) (see Non Patent Document 1).

In a case where the ecosystem function is expanded by the operation of the biological diversity, a method of designing (planning) the ecosystem is necessary such that an interaction between organisms that enhances a target ecosystem function such as an ecosystem function desired by the user is appropriately constructed.

As a method of designing an ecosystem, for example, there is a method of optimally planting plants called companion plants (see Non Patent Document 2).

A companion plant is a method of planting another type of plant that produces a (biological) interaction that produces a useful effect on a single plant species.

On the other hand, in the case of designing an ecosystem including several tens or more of various biological species, it is possible to partially implement an appropriate combination of biological species by applying conventional companion plants, but it is necessary to examine a huge number of combinations in order to implement an appropriate combination of biological species as a whole, and it is difficult for a person to directly perform the combination. For example, in Synecoculture (registered trademark), there is an implementation example in which an ecosystem including 200 or more kinds of plant species is expanded.

As another method of designing an ecosystem, for example, there is a method of evaluating congeniality to a living biological species existing in an agricultural field for each plant species desired to be introduced into the agricultural field on the basis of interaction occurring with the living biological species (see Patent Document 1). Note that, in the technology described in Patent Document 1, it is not assumed that appropriate combinations of various biological species are designed at the same time.

In order to design an ecosystem so as to generate an appropriate interaction, for example, an interaction that enhances a target ecosystem function in a wide variety of biological species, a database including comprehensive information is necessary as interaction information indicating the interaction.

The database including comprehensive interaction information is described in Non Patent Documents 3 and 4, for example.

In an analysis tool utilizing Global Biotic Interactions (Globi) described in Non Patent Document 3, it is possible to search for a biological species that causes an interaction with an input biological species.

Moreover, in the analysis tool utilizing Globi, search results of biological species can be displayed on a network in which biological species are used as nodes (https://www.globalbioticinteractions.org). The display of a network having biological species as nodes is useful for understanding interactions occurring between biological species. Note that the analysis tool utilizing Globi only displays a network for input of one biological species, and cannot input a plurality of biological species.

### CITATION LIST

### Patent Document

Patent Document 1: WO 2016/039176

### Non Patent Document

Non Patent Document 1: Funabashi, 2016, Synecoculture Practice Manual, 2016 edition, Sony Computer Science Laboratory (https://synecoculture.sonycsl.co.jp/public/2016 [symbol] 20 [symbol] [symbol] .pdf)
Non Patent Document 2: Kijima, 2011, Control of crop diseases and weed research by mixed cultivation with Allium plants and weeds, Weed Research Vol. 56 (1) 14-18
Non Patent Document 3: oelen, J. H., Simons, J. D., & Mungall, C. J. (2014). Global biotic interactions: An open infrastructure to share and analyze species-interaction datasets. Ecological Informatics, 24, 148-159. (https://doi.org/10.1016/j.ecoinf.2014.08.005)
Non Patent Document 4: arr, C. S., Wilson, N., Leary, P., Schulz, K., Lans, K., Walley, L., Hammock, J., Goddard, A., Rice, J., Studer, M., Holmes, J., & Corrigan, J. R. (2014). The Encyclopedia of Life v2: Providing Global Access to Knowledge About Life on Earth. Biodiversity Data Journal, 2, e1079. (https://doi.org/10.3897/BDJ.2.e1079)

### SUMMARY OF THE INVENTION

### Problems to be Solved by the Invention

By providing a combination of biological species appropriate to a target ecosystem function for a plurality of biological species, it is possible to support design and construction of a target ecosystem, that is, an ecosystem in which the target ecosystem function is exhibited.

The present technology has been made in view of such a situation, and makes it possible to provide a combination of biological species appropriate to a target ecosystem.

### Solutions to Problems

An information processing device or a first program of the present technology is an information processing device including a decision unit that constructs, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, the decision unit deciding a presentation combination that is a combination of biological species to be presented according to evaluation of the interaction network obtained by evaluating the interaction network by an evaluation method regarding an ecosystem, or a program for causing a computer to function as such an information processing device.

An information processing method of the present technology is an information processing method including constructing, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, and deciding a presentation combination that is a combination of biological species to be presented according to evaluation of the interaction network obtained by evaluating the interaction network by an evaluation method regarding an ecosystem.

In the information processing device, the information processing method, and the first program of the present technology, for each of a plurality of combinations of biological species selected from a plurality of biological species, an interaction network representing an interaction between a main biological species and a sub-biological species is constructed using the main biological species that is a biological species constituting the combination and the sub-biological species that is another biological species that causes an interaction with the main biological species as nodes, and a presentation combination that is a combination of biological species to be presented is decided according to evaluation of the interaction network obtained by evaluating the interaction network by an evaluation method regarding an ecosystem.

A second program of the present technology is a program for causing a computer to function as a transmission unit that transmits information of a plurality of biological species to an information processing device, and a display control unit that causes a display unit to display a presentation UI that presents a presentation combination obtained by the information processing device constructing, for each of a plurality of combinations of biological species selected from the plurality of biological species, an interaction network representing an interaction between a main biological species and a sub-biological species using the main biological species that is a biological species constituting the combination and the sub-biological species that is another biological species that causes an interaction with the main biological species as nodes, and deciding a presentation combination that is a combination of biological species to be presented according to evaluation of the interaction network obtained by evaluating the interaction network by an evaluation method regarding an ecosystem.

In the second program of the present technology, information of a plurality of biological species is transmitted to the information processing device. Then, a presentation UI is displayed, the presentation UI presenting a presentation combination obtained by the information processing device constructing, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, and deciding a presentation combination that is a combination of biological species to be presented according to evaluation of the interaction network obtained by evaluating the interaction network by an evaluation method regarding an ecosystem.

Note that the information processing devices may be independent devices or may be internal blocks constituting one device.

The program can be provided by being transmitted via a transmission medium or by being recorded on a recording medium.

### BRIEF DESCRIPTION OF DRAWINGS

FIG. 1 is a diagram illustrating a configuration example of one embodiment of an information processing system to which the present technology is applied.

FIG. 2 is a diagram illustrating a hardware configuration example of a terminal 11.

FIG. 3 is a diagram illustrating a hardware configuration example of a server 12.

FIG. 4 is a diagram illustrating an example of a use case of an information processing system 10.

FIG. 5 is a block diagram illustrating a first functional configuration example of a terminal 11.

FIG. 6 is a block diagram illustrating a functional configuration example of a server 12.

FIG. 7 is a diagram illustrating a first example of processing of the information processing system 10.

FIG. 8 is a block diagram illustrating a first configuration example of a decision unit 52.

FIG. 9 is a diagram illustrating an example of evaluation method information indicating an evaluation method for evaluating an interaction network.

FIG. 10 is a diagram illustrating an example of processing of the first configuration example of the decision unit 52.

FIG. 11 is a block diagram illustrating a second functional configuration example of the terminal 11.

FIG. 12 is a block diagram illustrating a second configuration example of the decision unit 52.

FIG. 13 is a block diagram illustrating a third configuration example of the decision unit 52.

FIG. 14 is a diagram illustrating an example of ranking of main biological species constituting a presentation combination by a ranking unit 111.

FIG. 15 is a diagram illustrating a display example of a presentation UI.

FIG. 16 is a diagram illustrating a display example of a presentation UI displayed in a case where an operation on the presentation UI is performed.

FIG. 17 is a diagram illustrating an example of processing of the information processing system 10 performed according to a user's operation on a presentation combination presented by the presentation UI.

FIG. 18 is a diagram illustrating a second example of processing of the information processing system 10.

FIG. 19 is a diagram illustrating an example of an interaction network for an additional combination obtained by adding a species registered in the additional list to a combination of species selected from a plurality of biological species registered in a biological species list.

FIG. 20 is a diagram illustrating a third example of processing of the information processing system 10.

FIG. 21 is a diagram illustrating a fourth example of processing of the information processing system 10.

FIG. 22 is a diagram illustrating a display example of a presentation UI in a case where a biological species list is automatically generated.

FIG. 23 is a diagram illustrating another display example of the presentation UI.

FIG. 24 is a diagram for describing processing of updating the interaction information of the database 13 performed by the information processing system 10.

FIG. 25 is a block diagram illustrating a fourth configuration example of the decision unit 52.

FIG. 26 is a diagram illustrating a fifth example of processing of the information processing system 10.

FIG. 27 is a diagram illustrating interaction information used in a first specific example of decision of a presentation combination.

FIG. 28 is a diagram illustrating an interaction network constructed for a combination of four biological species of rape, cucumber, green onion, and Robinia pseudoacacia.

FIG. 29 is a diagram illustrating interaction paths searched from an interaction network.

FIG. 30 is a diagram illustrating evaluation scores of an interaction network for each of all combinations of plant species generated from a biological species list in which rape, cucumber, green onion, and Robinia pseudoacacia are registered.

FIG. 31 is a diagram illustrating interaction information used in a second specific example of decision of a presentation combination.

FIG. 32 is a diagram illustrating an interaction network generated for an additional combination obtained by adding an observed animal species of Japanese parrotfish, brassy chub, purple sea urchin, and octopus to a combination of related biological species bigfin reef squid, rabbitfish, moray eel, spiny lobster, and striped beakfish.

FIG. 33 is a diagram illustrating an interaction network generated for an additional combination obtained by adding an observed animal species of Japanese parrotfish, brassy chub, purple sea urchin, and octopus to a combination of related biological species of moray eels and spiny lobsters.

FIG. 34 is a diagram illustrating a calculation result of a predation suppression score.

FIG. 35 is a diagram illustrating evaluation scores of an interaction network for additional combinations obtained by adding an observed animal species registered in an additional list to all combinations of 0 or more related animal species generated from a biological species list.

### MODE FOR CARRYING OUT THE INVENTION

<One Embodiment of Information Processing System to which Present Technology is Applied>

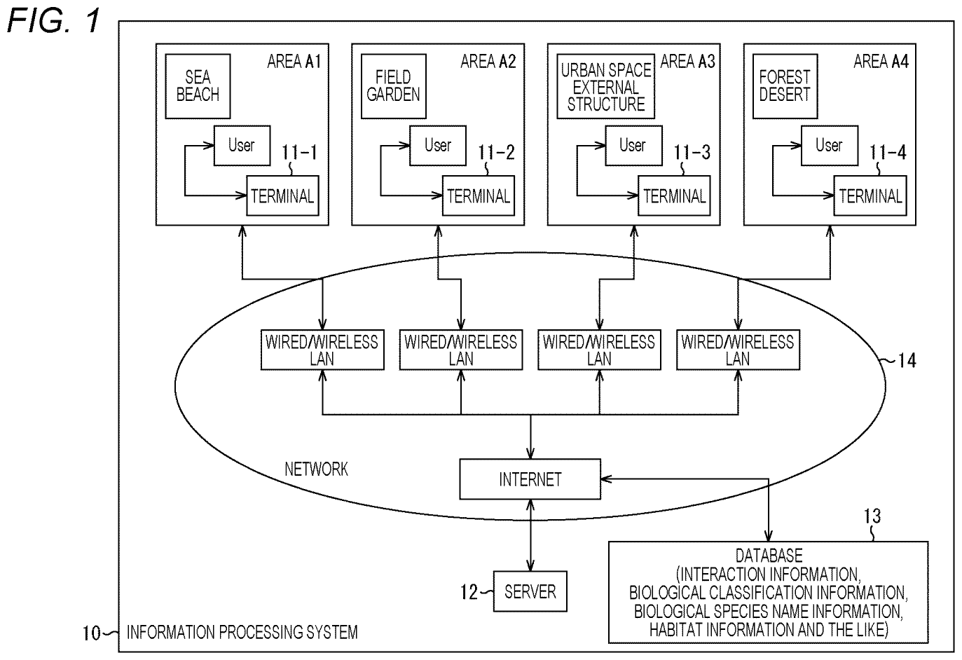

FIG. 1 is a diagram illustrating a configuration example of one embodiment of an information processing system to which the present technology is applied.

An information processing system 10 constitutes an ecosystem support system that supports design, construction, and the like of a target ecosystem by presenting a combination of biological species appropriate for the target ecosystem from combinations of biological species such as plants, animals, and microorganisms.

The information processing system 10 includes one or more terminals 11-i, one or more servers 12, and a database 13. The terminal 11-i, the server 12, and the database 13 can communicate with each other via a network 14 including a wired local area network (LAN), a wireless LAN, the Internet, a mobile communication network such as 5G, and the like.

In FIG. 1, four terminals 11-1, 11-2, 11-3, and 11-4 are provided as the terminals 11-i, but as the number of terminals 11-i, 1 to 3, or 5 or more can be employed. Hereinafter, the terminals 11-1, 11-2, 11-3, and 11-4 will be referred to as a terminal 11 unless it is particularly necessary to distinguish them.

Furthermore, in FIG. 1, one server 12 is provided as the server 12, but a plurality of servers 12 can be provided. In a case where a plurality of servers 12 is provided, the plurality of servers 12 can be caused to perform processing described below in a distributed manner. Furthermore, for the plurality of servers 12, terminals 11 for which the servers are responsible can be assigned, and each server 12 can be made to perform processing only for the terminals 11 for which it is responsible.

Moreover, the information processing system 10 can cause the terminal 11 to perform some or all of the processing performed by the server 12. In a case where the terminal 11 is caused to perform all the processing performed by the server 12, the information processing system 10 can be configured without providing the server 12.

The terminal 11 includes, for example, a personal computer (PC), a mobile terminal such as a smartphone, or the like, and is operated by the user.

The user can operate the terminal 11 in an area where the user lives, an area where the ecosystem is constructed, or any other area, and can input (names of) a plurality of biological species that are possibilities for introduction in constructing the ecosystem, an evaluation method for evaluating an interaction network to be described later, and the like.

In FIG. 1, the terminal 11-1 is located in an area A1 where the sea and a beach exist, and the terminal 11-2 is located in an area A2 where a field and a garden exist. The terminal 11-3 is located in an area A3 where an urban space and an external structure exists, and the terminal 11-4 is located in an area A4 where a forest and a desert exists.

The terminal 11 transmits, to the server 12 (via the network 14), a biological species list in which a plurality of biological species (names) is registered as information of the plurality of biological species input according to the operation of the user, evaluation method information indicating an evaluation method, and other necessary information.

Furthermore, the terminal 11 receives, for example, an image as a presentation user interface (UI) that presents a combination of biological species appropriate for a target ecosystem transmitted from the server 12 (via the network 14). The terminal 11 displays, for example, a presentation UI, thereby presenting the user with an appropriate combination of biological species.

The server 12 generates a plurality of combinations of one or more biological species by selecting, for example, one or more biological species from a plurality of biological species. For example, the server 12 receives a biological species list as information of a plurality of biological species transmitted from the terminal 11 (via the network 14). Then, the server 12 generates a plurality of combinations of biological species by selecting one or more biological species from a plurality of biological species registered in the biological species list from the terminal 11.

The server 12 constructs, for each of a plurality of combinations of biological species, an interaction network (graph) representing an interaction between a main biological species and a sub-biological species using, as nodes, the main biological species that is a biological species constituting the combination and the sub-biological species that is another biological species that causes an (interbiological) interaction such as a phagocytosis relationship, a predation relationship, a symbiotic relationship, or a parasitic relationship with the main biological species.

Moreover, the server 12 evaluates the interaction network by an evaluation method regarding the ecosystem, and decides a presentation combination that is a combination of biological species to be presented according to an evaluation of the interaction network. For example, the server 12 receives the evaluation method information transmitted from the terminal 11. Then, the server 12 evaluates the interaction network by the evaluation method indicated by the evaluation method information from the terminal 11, and decides the presentation combination according to the evaluation. For example, the server 12 decides a combination of the main biological species for the interaction network with the best evaluation (No. 1) as the presentation combination. In addition, in the server 12, for example, each combination of the main biological species with respect to the interaction network of which the evaluation is equal to or higher than a predetermined rank or the interaction network of which a value as the evaluation is equal to or higher than a threshold value can be decided as the presentation combination.

The server 12 generates a presentation UI that presents the presentation combination and transmits the presentation UI to the terminal 11 (via the network 14).

The server 12 refers to the database 13 (via the network 14) as necessary, and performs processing using the information stored in the database 13.

The database 13 stores big data as various types of information regarding biological species. For example, the database 13 stores interaction information, biological classification information, biological species name information, habitat information, and the like.

The interaction information is information indicating (inter-organism) interaction occurring between two biological species, and includes, for example, information of two biological species that cause interaction and interaction occurring between the two biological species, and the like.

The biological species name information is information indicating a name of a biological species, and is, for example, information in which a general name and a scientific name of the biological species are associated with each other.

The habitat information is information indicating a habitat of a biological species, and is, for example, information in which the biological species and (position information such as coordinates indicating a range of) the habitat of the biological species are associated with each other.

The biological classification information is information indicating a classification (category) (hereinafter also referred to as biological classification) to which a biological species belongs in a case where the biological species is classified according to some rules.

Examples of the biological classification include classification by a phylogenetic tree, phylogenetic classification, classification by various attributes including a function of a living organism such as functional classification, and the like. The functional classification is classification based on the function of an organism, and the function of an organism includes, for example, an ecological function such as pollination of a specific plant species, or a physiological function such as expression of a specific compound.

The database 13 (the information stored therein) can be updated in response to an input from the user. That is, the database 13 can be updated by information input by the operation of the terminal 11 by the user.

Here, examples of the interaction that occurs between biological species include an interaction that acts positively and an interaction that acts negatively in construction of a target ecosystem. In constructing the target ecosystem, an overall optimum considering a trade-off relationship between an interaction that acts positively and an interaction that acts negatively in construction of the target ecosystem is necessary. In order to achieve overall optimization, it is necessary to obtain an optimal solution or an approximate solution of a combinational optimization problem for an enormous number of combinations of biological species.

In the server 12, the information processing system 10 constructs an interaction network by utilizing the interaction information as the big data stored in the database 13 for various combinations of biological species. Moreover, the information processing system 10 evaluates the interaction network for various combinations of biological species in the server 12 to obtain an appropriate combination of biological species as a solution. Any method can be employed as an evaluation method of the interaction network or a calculation method (algorithm) for obtaining the appropriate combination as a solution.

In the information processing system 10, as described above, in the server 12, the design and construction of an ecosystem including a wide variety of biological species are supported by optimizing the combination of the biological species, that is, by obtaining an appropriate combination of the biological species using the interaction network. In particular, in the server 12, an interaction network is constructed for each of a plurality of combinations of biological species selected from a plurality of biological species, and a presentation combination is decided from a plurality of combinations of biological species selected from the plurality of biological species according to an evaluation of the interaction network. Thus, it is possible to support the construction of an ecosystem including more various biological species as compared with a case where an ecosystem is constructed using only a network indicating an interaction with the biological species for one biological species. Furthermore, since the presentation combination is a combination of main biological species, it can be said that deciding the presentation combination according to the evaluation of the interaction network designs a combination of main biological species appropriate for constructing a target ecosystem (a combination of main biological species with a good evaluation of the interaction network). Moreover, since the sub-biological species constituting the interaction network for the presentation combination is a biological species that generates an interaction with the main biological species appropriate for construction of the target ecosystem, it can be said to be a sub-biological species appropriate for the construction of the target ecosystem. Therefore, deciding the presentation combination can also be said to design a sub-biological species appropriate for the construction of the target ecosystem as a result. Therefore, by deciding the presentation combination according to the evaluation of the interaction network, it is possible to design the main biological species and the sub-biological species appropriate for the construction of the target ecosystem.

### <Hardware Configuration Example of Terminal 11 and Server 12>

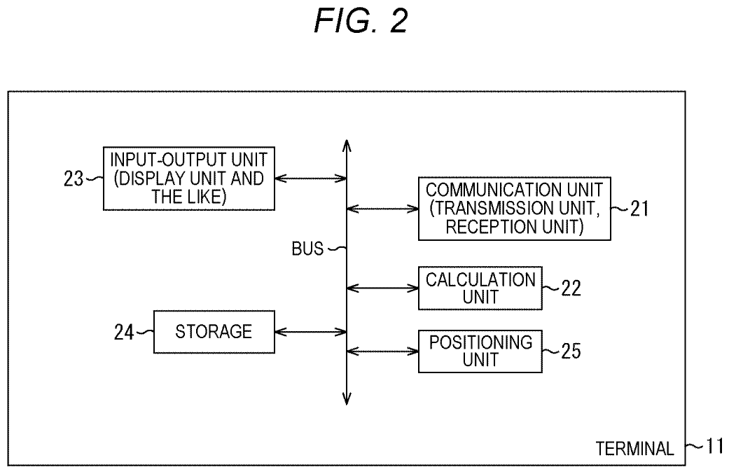

FIG. 2 is a diagram illustrating a hardware configuration example of the terminal 11.

The terminal 11 includes a communication unit 21, a calculation unit 22, an input-output unit 23, a storage 24, and a positioning unit 25. The communication unit 21 to the positioning unit 25 are connected to each other via a bus, and can exchange information.

The communication unit 21 functions as a transmission unit that transmits information and a reception unit that receives information via the network 14.

The calculation unit 22 includes a processor such as a central processing unit (CPU) or a digital signal processor (DSP), and performs various processes by executing a program recorded in the storage 24.

The input-output unit 23 includes a keyboard, a touch panel, a microphone, and the like, and receives various inputs such as an operation from the user. Furthermore, the input-output unit 23 includes a speaker and a display (display unit), and presents information to the user by outputting sound, displaying an image, or the like.

The storage 24 includes a semiconductor memory such as a random access memory (RAM) or a nonvolatile memory, a solid state drive (SSD), a hard disk drive (HDD), or the like. A program executed by the calculation unit 22, data necessary for processing of the calculation unit 22, and the like are recorded (stored) in the storage 24.

The program executed by the calculation unit 22 can be installed in a computer as the terminal 11 from a removable recording medium such as a digital versatile disc (DVD) or a memory card, for example. Furthermore, for example, the program can be downloaded to the computer as the terminal 11 via the network 14 or the like and installed in the storage 24.

The positioning unit 25 forms, for example, a global positioning system (GPS), measures (positions) the position of the terminal 11, and outputs position information indicating the position, for example, latitude and longitude (and required altitude).

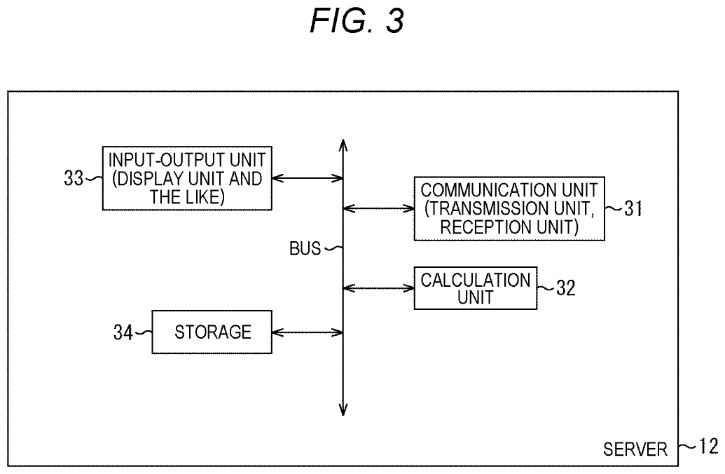

FIG. 3 is a diagram illustrating a hardware configuration example of the server 12.

The server 12 includes a communication unit 31, a calculation unit 32, an input-output unit 33, and a storage 34. Since the communication unit 31 to the storage 34 are configured similarly to the communication unit 21 to the storage 24 in FIG. 2, the description thereof will be omitted. Note that, as the communication unit 31 to the storage 34, those having higher performance such as capacity and processing speed than the communication unit 21 to the storage 24 can be employed.

### <Example of Use Case of Information Processing System 10>

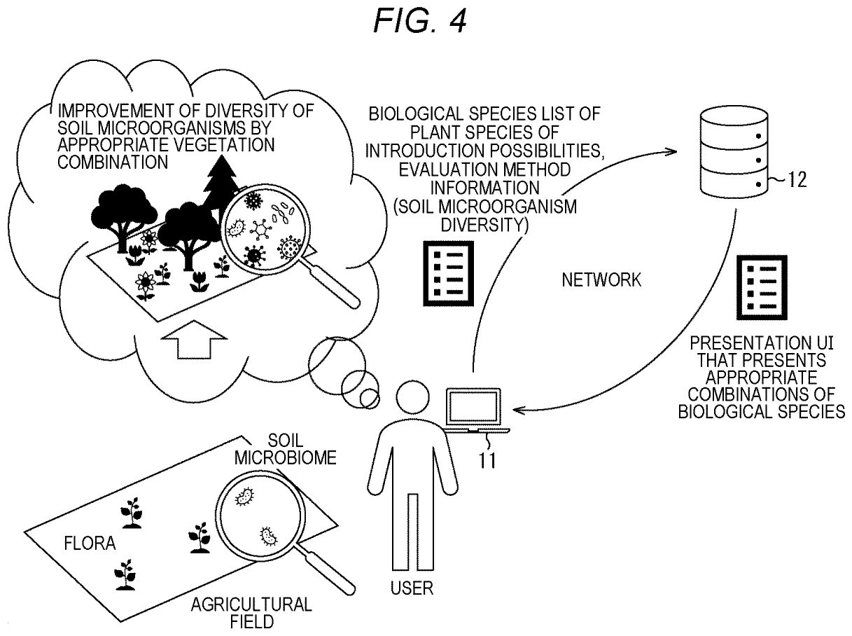

FIG. 4 is a diagram illustrating an example of a use case of the information processing system 10.

In FIG. 4, for example, the user intends to introduce a plant species (vegetation) in an agricultural field of a target for constructing (including expanding) an ecosystem, with improvement in species diversity of a soil microbiome as (exertion of) a target ecosystem function.

In this case, the user operates the terminal 11 to input a plurality of possibilities for the plant species to be introduced into the agricultural field and an evaluation method for highly evaluating improvement in the species diversity of the soil microbiome.

The terminal 11 generates a biological species list in which a plurality of plant species as possibilities to be introduced into the agricultural field input by the user's operation are registered, and evaluation method information indicating an evaluation method input by the user's operation, and transmits the evaluation method information to the server 12.

The server 12 receives the biological species list and the evaluation method information from the terminal 11. The server 12 generates a plurality of combinations of one or more plant species selected from a plurality of plant species registered in the plant species list. The server 12 constructs, for each of a plurality of combinations of plant species, an interaction network representing an interaction between the main biological species and the sub-biological species using the main biological species that is a biological species (plant species) constituting the combination and the sub-biological species that is another biological species that causes an interaction with the main biological species as nodes.

Moreover, the server 12 evaluates the interaction network for each combination by the evaluation method indicated by the evaluation method information, and decides a combination with good evaluation as a presentation combination that is a combination of plant species to be presented according to the evaluation.

In this case, the interaction network is evaluated by an evaluation method in which improvement in the species diversity of the soil microbiome is highly evaluated, and thus the combination for improving the species diversity of the soil microbiome is decided as the presentation combination.

The server 12 generates a presentation UI that presents the presentation combination and transmits the presentation UI to the terminal 11.

The terminal 11 receives and displays the presentation UI from the server 12, thereby presenting the presentation combination to the user.

In the present case, the presentation combination is a combination that improves the species diversity of the soil microbiome, and therefore, by presenting the presentation combination, the user can recognize the combination of plant species that improves the species diversity of the soil microbiome. Then, by introducing such a combination of plant species into the agricultural field, it is possible to improve the species diversity of the soil microbiome (construct an ecosystem in which the species diversity of the soil microbiome is improved) in the agricultural field.

In the information processing system 10, it is possible to present a combination of biological species appropriate for exerting other various ecosystem functions in addition to presenting a combination for improving the species diversity of the soil microbiome.

For example, the information processing system 10 can present a combination of biological species that improves an adjustment service.

For example, it is possible to present a combination of biological species that suppresses the activity and proliferation of pathogenic microorganisms (pathogenic microorganisms). In this case, it is possible to reduce the influence of the pathogenic microorganisms on the biological species contributing to the adjustment service and improve the adjustment service by introducing the combination of the biological species that suppresses the pathogenic microorganisms.

Also, for example, a combination of biological species that inhibits the growth of pest species can be presented. In this case, by introducing a combination of biological species that suppresses proliferation of pest species, it is possible to suppress a mass occurrence of exogenous pest species. Thus, the influence of the pest species on the adjustment service can be reduced, and the adjustment service can be improved.

In addition, for example, in the information processing system 10, it is possible to present a combination of species of fish that improves diversity of cnidarians such as corals, jellyfish, and sea urchins, and seaweeds such as kombu and wakame in a predetermined space (in the sea). The presentation of the combination of fish species that improves the diversity of cnidarians and seaweeds can contribute to, for example, ecosystem construction type aquaculture business in aquaculture and mixed dense water tank design in aquariums.

### <First Functional Configuration Example of Terminal 11>

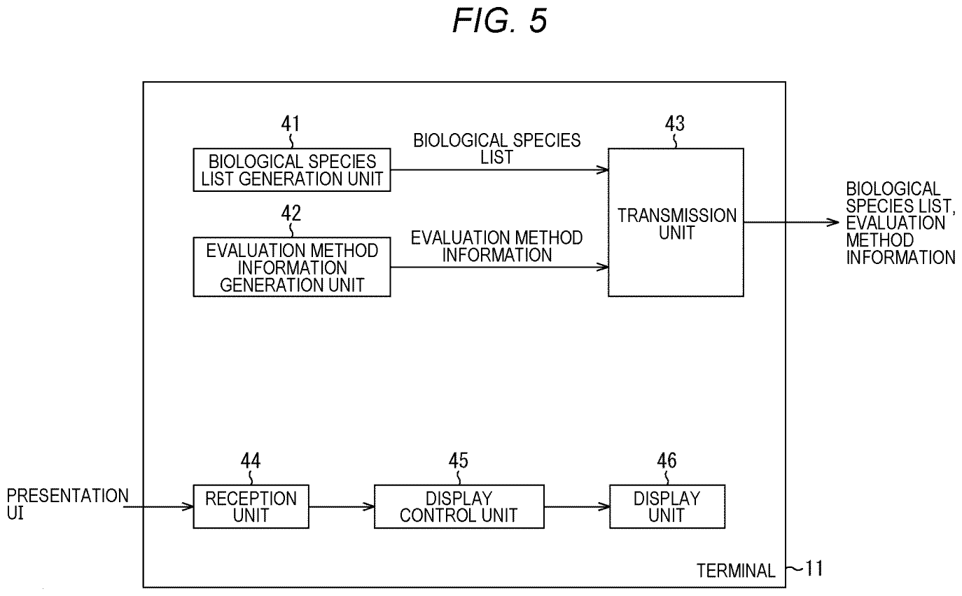

FIG. 5 is a block diagram illustrating a first functional configuration example of the terminal 11. The functional configuration of the terminal 11 is functionally implemented by the calculation unit 22 in FIG. 2 executing a program.

In FIG. 5, the terminal 11 includes a biological species list generation unit 41, an evaluation method information generation unit 42, a transmission unit 43, a reception unit 44, a display control unit 45, and a display unit 46.

For example, the biological species list generation unit 41 generates a biological species list in which a plurality of biological species (names) is registered according to the operation of the terminal 11 by the user, and supplies the biological species list to the transmission unit 43.

The user can input any biological species as the biological species to be registered in the biological species list by operating the terminal 11. For example, the user can input, as the species to be registered in the biological species list, a species that the user is constructing an ecosystem or is going to introduce it into a growth place where the user is going to construct an ecosystem, a species existing in the growth place, or the like.

Furthermore, a sensor such as a camera is mounted on the terminal 11, and a growth place or the like can be sensed by the sensor. In this case, the biological species list generation unit 41 of the terminal 11 can recognize a biological species existing in the growth place and generate a biological species list in which the biological species are registered by performing processing such as image recognition on the sensing result of the sensor.

The evaluation method information generation unit 42 generates evaluation method information indicating an evaluation method for evaluating an interaction network in the server 12 according to, for example, the operation of the terminal 11 by the user, and supplies the evaluation method information to the transmission unit 43.

The interaction network represents an interaction between biological species using the biological species as a node, and is constructed in the server 12.

As an evaluation method for evaluating the interaction network, for example, an evaluation method for highly evaluating the improvement of the biological diversity can be employed. Furthermore, as the evaluation method, for example, an evaluation method in which it is highly evaluated that a target ecosystem function is exhibited, such as an evaluation method in which it is highly evaluated that pathogenic microorganisms are suppressed, and other evaluation methods regarding ecosystems (evaluation methods for evaluating ecosystems) can be employed.

By operating the terminal 11, the user can designate an evaluation method according to the purpose of the user such as a desire to improve the biological diversity, for example.

The transmission unit 43 transmits various types of information to the server 12, the database 13, and the like. For example, the transmission unit 43 transmits the biological species list from the biological species list generation unit 41 and the evaluation method information from the evaluation method information generation unit 42 to the server 12.

The reception unit 44 receives various types of information from the server 12, the database 13, and the like. For example, the reception unit 44 receives the presentation UI transmitted from the server 12 and supplies the presentation UI to the display control unit 45.

The display control unit 45 performs display control to display an image on the display unit 46. For example, the display control unit 45 causes the display unit 46 to display the image as the presentation UI from the reception unit 44.

The display unit 46 displays an image according to display control of the display control unit 45.

### <Functional Configuration Example of Server 12>

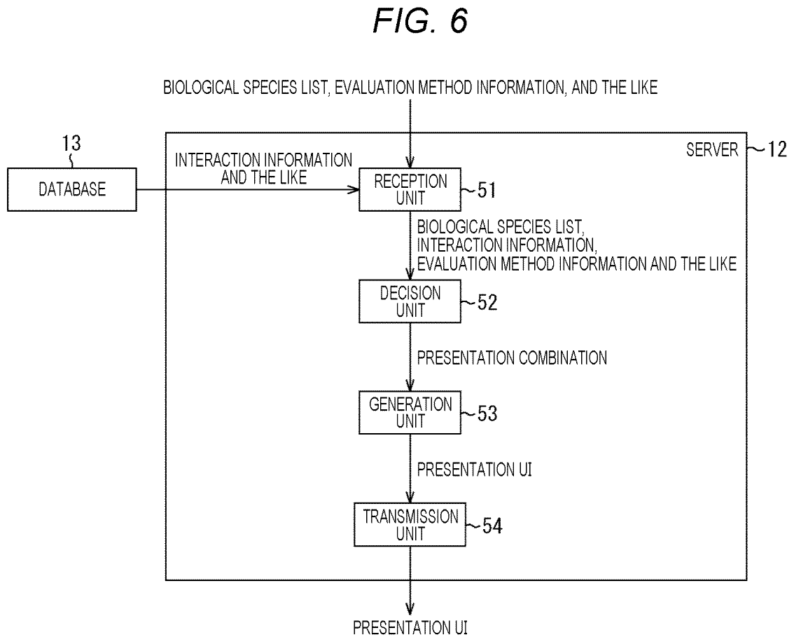

FIG. 6 is a block diagram illustrating a functional configuration example of the server 12.

The functional configuration of the server 12 is functionally implemented by the calculation unit 32 in FIG. 3 executing a program.

In FIG. 6, the server 12 includes a reception unit 51, a decision unit 52, a generation unit 53, and a transmission unit 54.

The reception unit 51 functions as an acquisition unit that acquires various types of information by receiving the information from the terminal 11, the database 13, or the like. For example, the reception unit 51 receives the biological species list, the evaluation method information, and the like transmitted from the terminal 11, and supplies the biological species list, the evaluation method information, and the like to the decision unit 52. Furthermore, the reception unit 51 receives the interaction information and the like from the database 13 and supplies the interaction information and the like to the decision unit 52.

The decision unit 52 decides a presentation combination, which is a combination of biological species to be presented, by using the information supplied from the reception unit 51.

For example, the decision unit 52 generates a plurality of combinations of biological species by selecting one or more biological species from the plurality of biological species registered in the biological species list from the reception unit 51.

Using the interaction information from the reception unit 51, the decision unit 52 constructs, for each of a plurality of combinations of biological species, an interaction network representing interaction between the main biological species and the sub-biological species, using the main biological species constituting the combination and the sub-biological species interacting with the main biological species as nodes.

The decision unit 52 evaluates the interaction network by the evaluation method indicated by the evaluation method information from the reception unit 51. The decision unit 52 decides a presentation combination that is a combination of biological species to be presented according to the evaluation of the interaction network, and supplies the presentation combination to the generation unit 53.

The generation unit 53 generates a presentation UI that presents the presentation combination from the decision unit 52, and supplies the presentation UI to the transmission unit 54.

The transmission unit 54 transmits various types of information to the terminal 11, the database 13, and the like. For example, the transmission unit 54 transmits the presentation UI from the generation unit 53 to the terminal 11 that has transmitted the biological species list and the evaluation method information used for generating the presentation UI.

Note that, here, the server 12 generates a presentation UI that presents a presentation combination and transmits the presentation UI to the terminal 11, and the terminal 11 receives and displays the presentation UI. However, in the server 12, instead of the presentation UI, (information of) the presentation combination can be transmitted to the terminal 11, and the terminal 11 can receive the presentation combination, generate the presentation UI that presents the presentation combination, and display the presentation combination. Hereinafter, the server 12 generates a presentation UI and transmits the presentation UI to the terminal 11, and the terminal 11 receives and displays the presentation UI.

### <First Example of Processing of Information Processing System 10>

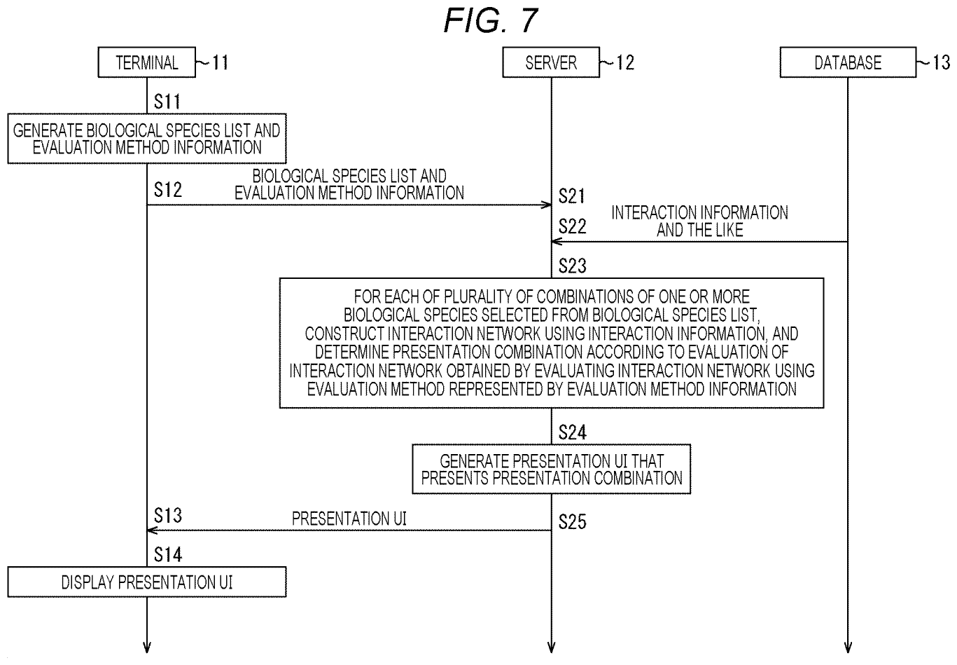

FIG. 7 is a diagram illustrating a first example of processing of the information processing system 10.

In the terminal 11 (FIG. 5), in step S11, the biological species list generation unit 41 generates a biological species list according to a user's operation or the like, and supplies the biological species list to the transmission unit 43. Moreover, in step S11, the evaluation method information generation unit 42 generates the evaluation method information according to the operation of the user and supplies the evaluation method information to the transmission unit 43.

In step S12, the transmission unit 43 transmits the biological species list and the evaluation method information to the server 12.

In the server 12 (FIG. 6), in step S21, the reception unit 51 receives the biological species list and the evaluation method information transmitted from the terminal 11, and supplies the biological species list and the evaluation method information to the decision unit 52.

In step S22, the reception unit 51 accesses the database 13, receives necessary information, for example, the interaction information including information of other biological species that causes (has) interaction with the biological species registered in the biological species list, and supplies the interaction information to the decision unit 52.

In step S23, the decision unit 52 generates a plurality of combinations of biological species by selecting one or more biological species from the plurality of biological species registered in the biological species list. Moreover, the decision unit 52 constructs, for each of the plurality of combinations of biological species, an interaction network including, as nodes, a main biological species constituting the combination and a sub-biological species that causes an interaction with the main biological species by using the interaction information.

The interaction network includes information of main biological species and sub-biological species (for example, the name and the like of a biological species) and information of interaction (for example, the name and the like of (the type of) the interaction).

It can be said that the interaction network constructed for the combination of the biological species represents a biological species flora (group) that can be constructed in a case where the combination of the biological species is introduced and the interaction between the biological species constituting the biological species flora.

Therefore, it can be said that constructing the interaction network for the combination of biological species predicts a biological species flora that can be constructed in a case where the combination of biological species is introduced.

In step S23, the decision unit 52 evaluates the interaction network by the evaluation method indicated by the evaluation method information, decides a presentation combination that is a combination of biological species to be presented according to the evaluation, and supplies the presentation combination to the generation unit 53.

In step S24, the generation unit 53 generates a presentation UI that presents the presentation combination from the decision unit 52, and supplies the presentation UI to the transmission unit 54.

For example, the generation unit 53 can generate, as the presentation UI, a name image that presents the name of the biological species constituting the presentation combination in a list format or the like, or a network image that presents the interaction network for the presentation combination. Furthermore, the generation unit 53 can generate, for example, an image including both the name image and the network image as the presentation UI.

In step S25, the transmission unit 54 transmits the presentation UI to the terminal 11.

In the terminal 11 (FIG. 5), in step S13, the reception unit 44 receives the presentation UI transmitted from the server 12 and supplies the presentation UI to the display control unit 45.

In step S14, the display control unit 45 causes the display unit 46 to display the image as the presentation UI.

As described above, the server 12 constructs, for each of a plurality of combinations of biological species selected from the biological species list, an interaction network including, as nodes, the main biological species constituting the combination and the sub-biological species that causes an interaction with the main biological species, and decides a presentation combination that is a combination of biological species to be presented according to the evaluation of the interaction network obtained by evaluating the interaction network by the evaluation method regarding the ecosystem indicated by the evaluation method information.

Therefore, from the combinations of the biological species registered in the biological species list, it is possible to provide a combination of the biological species with a good evaluation regarding the ecosystem of the interaction network, that is, a combination of the biological species appropriate for constructing the target ecosystem.

For example, the user can cause the biological species list generation unit 41 to generate a biological species list in which only biological species existing in a growth place where an ecosystem is constructed or only biological species to be introduced (attempted to be introduced) to the growth place are registered, by an operation of the terminal 11 or the like. Furthermore, for example, it is possible to cause the biological species list generation unit 41 to generate a biological species list in which both biological species existing in a growth place where an ecosystem is constructed and a biological species to be introduced into the growth place are registered.

For example, in a case where the biological species list in which only biological species existing in the growth place are registered is generated, a combination of biological species selected from only biological species already existing in the growth place is provided as a presentation combination. In this case, on the basis of the presentation combination, it is possible to construct an ecosystem in which the current state of the growth place, for example, biological species such as plants and microbiome existing in the land and space as the growth place are utilized as much as possible.

Note that an evaluation method for evaluating the interaction network can be set in the server 12 in advance. In a case where the interaction network is evaluated by the evaluation method preset in the server 12, it is not necessary to transmit the evaluation method information from the terminal 11 to the server 12, and the terminal 11 can be configured without including the evaluation method information generation unit 42.

### <First Configuration Example of Decision Unit 52>

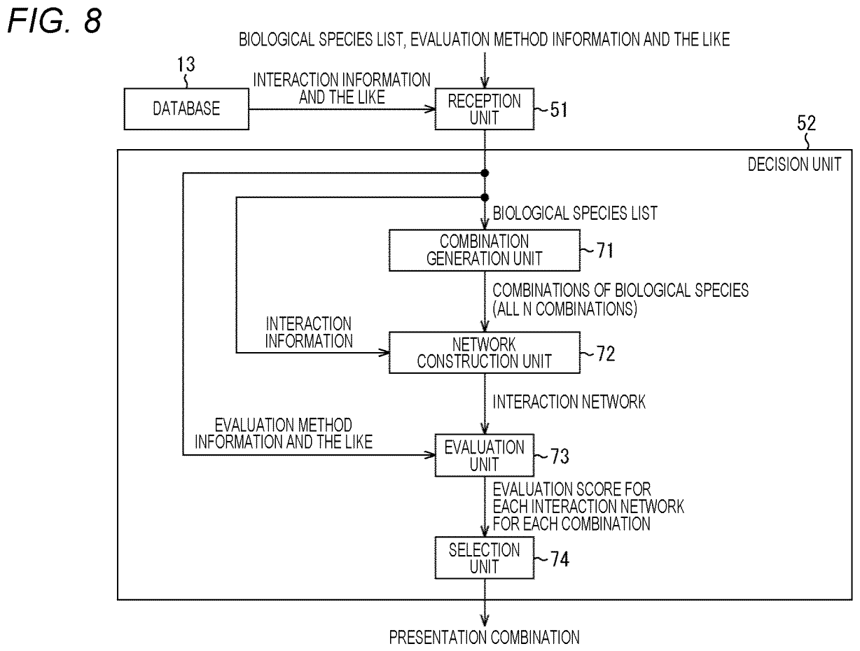

FIG. 8 is a block diagram illustrating a first configuration example of the decision unit 52 in FIG. 6.

In FIG. 8, the decision unit 52 includes a combination generation unit 71, a network construction unit 72, an evaluation unit 73, and a selection unit 74.

The biological species list is supplied from the reception unit 51 to the combination generation unit 71.

The combination generation unit 71 generates a plurality of combinations of biological species (main biological species) to be searched for interaction from the biological species registered in the biological species list. For example, the combination generation unit 71 generates N combinations, which are all combinations of one or more biological species, from the biological species registered in the biological species list as targets of interaction search. The combination generation unit 71 supplies all N combinations of biological species to the network construction unit 72.

The combination of the biological species is supplied from the combination generation unit 71 to the network construction unit 72, and the interaction information is supplied from the reception unit 51.

The network construction unit 72 constructs, for each of all N combinations of biological species from the combination generation unit 71, an interaction network representing an interaction occurring between the main biological species and the sub-biological species by searching for an interaction caused by the main biological species constituting the combination with another biological species and a sub-biological species that is another biological species that causes an interaction with the main biological species by using the interaction information.

For example, the network construction unit 72 sequentially selects all N combinations of biological species from the combination generation unit 71 as combinations of interest. Then, the network construction unit 72 searches for an interaction caused by the main biological species constituting the combination of interest with another biological species, and a sub-biological species that causes an interaction with the main biological species by using the interaction information. Moreover, the network construction unit 72 constructs an interaction network including nodes representing biological species (main biological species and sub-biological species) and links representing interactions between biological species (interactions between the main biological species and the sub-biological species), and supplies the interaction network to the evaluation unit 73.

The evaluation unit 73 is supplied with an interaction network for each of all N combinations of biological species from the network construction unit 72, and is also supplied with evaluation method information from the reception unit 51.

The evaluation unit 73 sets an evaluation method for evaluating the interaction network according to the evaluation method information from the terminal 11 as an input from the outside, and evaluates the interaction network for each of all the N combinations of biological species by the evaluation method.

For example, the evaluation unit 73 sets a calculation formula for an evaluation score according to the evaluation method indicated by the evaluation method information, and calculates an evaluation score of the interaction network according to the calculation formula. Note that, here, the larger the evaluation score, the better the evaluation.

The evaluation unit 73 supplies the evaluation score of the interaction network for each of all the N combinations of biological species to the selection unit 74.

The selection unit 74 detects the best evaluation score (maximum value) from the evaluation scores of the interaction networks for all the N combinations of biological species from the evaluation unit 73. The selection unit 74 selects a combination for the interaction network in which the best evaluation score is obtained from all the N combinations of biological species, decides the combination as the presentation combination, and supplies the presentation combination to the generation unit 53 (FIG. 6).

As described above, the decision unit 52 generates a plurality of combinations of biological species, for example, all N combinations, from the biological species registered in the biological species list, and decides the combination having the best evaluation score of the interaction network from all the N combinations as the presentation combination.

In this case, the combination having the best evaluation regarding the ecosystem obtained by the evaluation method indicated by the evaluation method information is decided as the presentation combination from any combination of a plurality of biological species input by the user operating the terminal 11.

Therefore, according to the presentation combination, it is possible to provide the combination having the best evaluation regarding the ecosystem obtained by the evaluation method indicated by the evaluation method information from the plurality of biological species that the user intends to introduce into the growth place.

Furthermore, since the presentation combination is explicitly presented, the user has an incentive to actively (autonomously) introduce the presentation combination. Moreover, by actually introducing the biological species constituting the presentation combination, it is possible to efficiently construct a target ecosystem.

### <Evaluation Method Information>

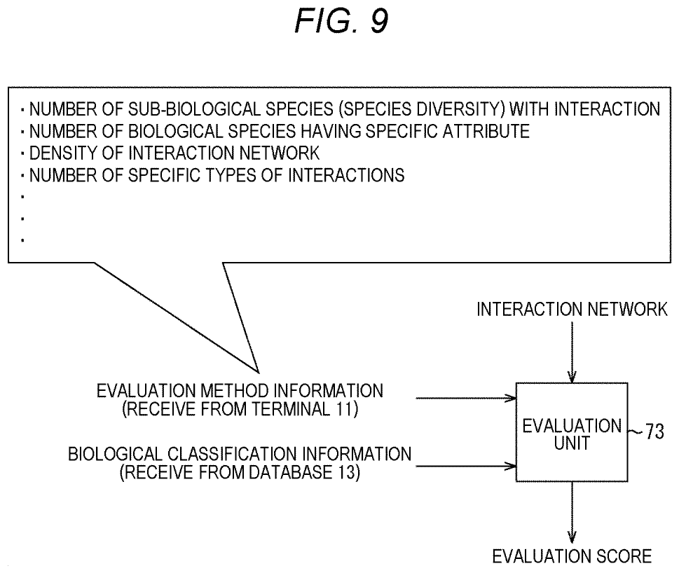

FIG. 9 is a diagram illustrating an example of the evaluation method information indicating the evaluation method for evaluating the interaction network.

In the terminal 11 (FIG. 5), the evaluation method information generation unit 42 generates the evaluation method information indicating the evaluation method for evaluating the interaction network according to the operation of the terminal 11 by the user.

In the server 12 (FIG. 8), the evaluation unit 73 sets the evaluation method of the interaction network to the evaluation method indicated by the evaluation method information, and evaluates the interaction network by the evaluation method.

Therefore, the user can designate an evaluation method for obtaining a combination of biological species appropriate to (construction of) the target ecosystem by operating the terminal 11.

For example, it is possible to designate an evaluation method for performing evaluation according to the number of sub-biological species (species diversity) in the interaction network or an evaluation method for performing evaluation according to the number of biological species having a specific attribute in the interaction network. Furthermore, for example, an evaluation method for performing evaluation according to the density (number of links) of the interaction network, an evaluation method for performing evaluation according to the number of specific types of interactions in the interaction network, and the like can be designated.

In the evaluation of the interaction network, the evaluation unit 73 refers to necessary information stored in the database 13 depending on the evaluation method information.

For example, in a case where the evaluation method information indicates an evaluation method for performing evaluation according to the number of biological species having a specific attribute in the interaction network, the evaluation unit 73 refers to the biological classification information stored in the database 13. Thus, the evaluation unit 73 recognizes an attribute of a biological species constituting the interaction network and counts the number of biological species having a specific attribute in the interaction network. Then, the evaluation unit 73 evaluates the interaction network according to the number of biological species having a specific attribute.

In the evaluation unit 73, in the setting of the evaluation method of the interaction network, for example, a calculation formula of an evaluation score according to the evaluation method indicated by the evaluation method information is set.

For example, in a case where the user operates the terminal 11 to input that the purpose of constructing the ecosystem is to ensure the safety of human health, the evaluation method information generation unit 42 generates evaluation method information indicating an evaluation method in which a higher evaluation is obtained as the number of specific microbial species, such as pathogenic microorganisms, that cause harmful effects on health decreases in order to ensure the safety of human health.

The evaluation unit 73 sets a calculation formula for calculating a larger evaluation score as the number of specific microbial species is smaller according to the evaluation method indicated by the evaluation method information, and calculates the evaluation score of the interaction network according to the calculation formula.

### <Processing of First Configuration Example of Decision Unit 52>

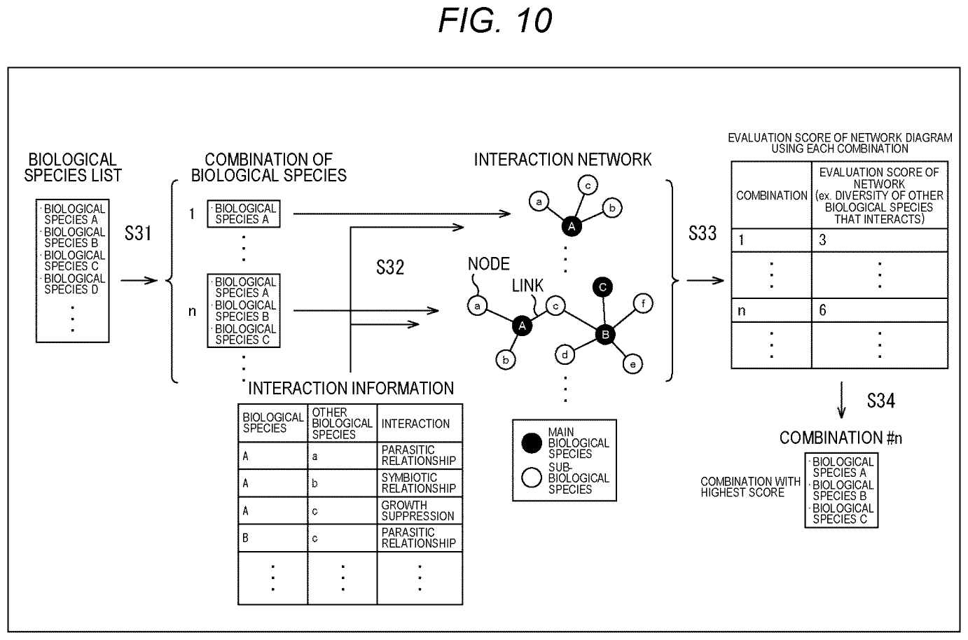

FIG. 10 is a diagram illustrating an example of processing of the first configuration example of the decision unit 52.

In the decision unit 52 (FIG. 8), in step S31, the combination generation unit 71 generates a plurality of combinations of one or more biological species (main biological species) to be searched for interaction from the species registered in the biological species list from the terminal 11, and supplies the combinations to the network construction unit 72.

In FIG. 10, biological species A, B, C, . . . are registered in the biological species list, and all combinations of one or more biological species are generated from the biological species A, B, C, . . . registered in such a biological species list. That is, all N combinations of biological species of a combination #1 of only the biological species A, . . . , and a combination #n of the biological species A to C, . . . are generated.

In step S32, the network construction unit 72 constructs the interaction network for each of all the N combinations of biological species from the combination generation unit 71 by using the interaction information from the database 13.

In the interaction information, two biological species, that is, a biological species and another biological species that causes an interaction with the biological species are associated with the interaction that occurs between the two biological species.

In FIG. 10, the database 13 stores the interaction information indicating that the biological species A is in a parasitic relationship in which the biological species A parasitizes another biological species a, the biological species A is in a symbiotic relationship in which the biological species A lives together with another biological species b, the biological species A is in a growth suppression relationship in which the growth of another biological species c is suppressed, and the like.

The network construction unit 72 sequentially selects all the N combinations of biological species from the combination generation unit 71 as combinations of interest. Moreover, the network construction unit 72 searches for an interaction caused by the main biological species constituting the combination of interest with another biological species and a sub-biological species that causes an interaction with the main biological species by using the interaction information.

Then, the network construction unit 72 constructs an interaction network including nodes representing biological species (main biological species and sub-biological species) and links representing interactions between biological species (interactions between the main biological species and the sub-biological species), and supplies the interaction network to the evaluation unit 73.

In FIG. 10, for example, for the combination #1 of only the main biological species A, an interaction network is constructed in which a node of the main biological species A and each of nodes of the sub-biological species a to c that cause interaction with the main biological species A are connected by a link representing an interaction. Here, in FIG. 10, the node of the main biological species is indicated by a black circle, and the node of the sub-biological species is indicated by a white circle. This similarly applies to the following drawings.

In FIG. 10, for example, an interaction network is constructed in which the node of the main biological species A and the nodes of the sub-biological species a to c that cause an interaction with the main biological species A are connected by links with respect to the combination #n of the biological species A to C. Moreover, in FIG. 10, an interaction network is constructed in which the node of the main biological species B and each of the nodes of the sub-biological species c to f and C that cause interaction with the main biological species B are connected by links.

Note that, in the combination #n of the biological species A to C, the main biological species B and C cause an interaction, and are also sub-biological species that are other biological species that causes an interaction with the main biological species.

Furthermore, here, the network construction unit 72 searches for a sub-biological species that directly causes an interaction with the main biological species, but the network construction unit 72 can also search for a sub-biological species that indirectly causes an interaction with the main biological species, for example.

That is, in the network construction unit 72, in addition to the sub-biological species that directly causes an interaction with the main biological species, another biological species that directly causes an interaction with the sub-biological species can also be searched for.

However, if the sub-biological species that indirectly causes an interaction with the main biological species is also searched, the scale of the interaction network and the calculation cost required for the processing become enormous. Therefore, whether or not to search for the sub-biological species that indirectly causes an interaction with the main biological species can be set in consideration of the calculation cost required for the processing.

Hereinafter, in the construction of the interaction network, the sub-biological species that directly causes an interaction with the main biological species is searched for, and the sub-biological species that indirectly causes an interaction with the main biological species is not searched for.

In step S33, the evaluation unit 73 sets an evaluation score calculation formula according to the evaluation method information from the terminal 11. Then, the evaluation unit 73 calculates the evaluation score of the interaction network for each of all the N combinations of biological species according to the calculation formula, and supplies the evaluation score to the selection unit 74.

In FIG. 10, in the interaction network, a calculation formula for calculating the diversity of other biological species that cause an interaction with the main biological species, that is, the number of sub-biological species (the number of white circles) as an evaluation score is set, and the evaluation score is calculated according to the calculation formula.

In step S34, the selection unit 74 detects the best evaluation score from the evaluation score of the interaction network for each of all the N combinations of biological species from the evaluation unit 73. The selection unit 74 selects a combination for the interaction network in which the best evaluation score is obtained from all the N combinations of biological species, and decides the selected combination as the presentation combination.

In FIG. 10, the evaluation score of the interaction network for the combination #n of the biological species A to C is the best, and the combination #n of the biological species A to C is decided as the presentation combination.

### <Second Functional Configuration Example of Terminal 11>

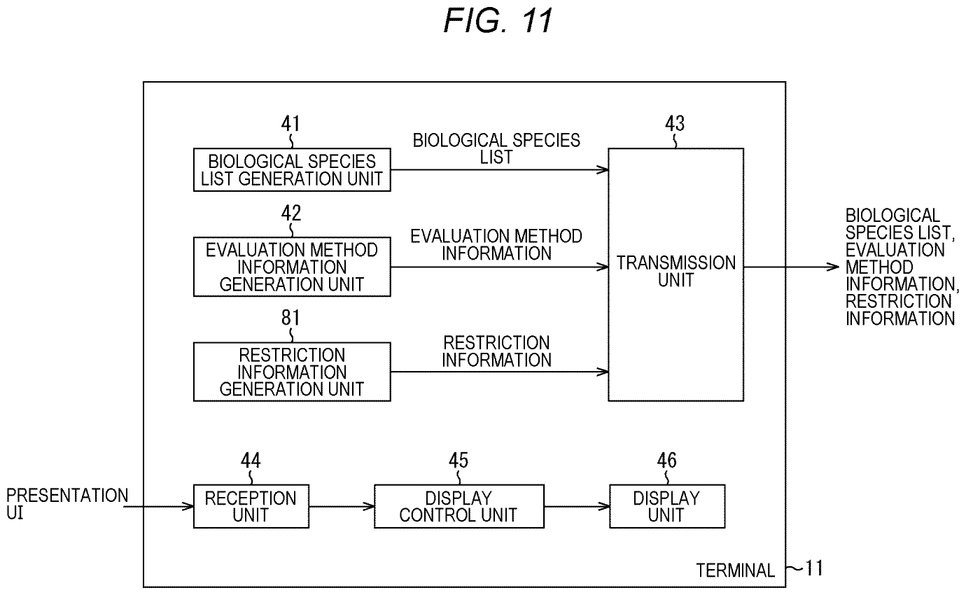

FIG. 11 is a block diagram illustrating a second functional configuration example of the terminal 11.

Note that, in the drawing, the components corresponding to those in FIG. 5 are assigned with the same reference signs, and explanation thereof is hereinafter appropriately omitted.

In FIG. 11, the terminal 11 includes the biological species list generation unit 41 to the display unit 46, and a restriction information generation unit 81.

Therefore, the terminal 11 of FIG. 11 is common to the case of FIG. 5 in that the biological species list generation unit 41 to the display unit 46 are provided, and is different from the case of FIG. 5 in that the restriction information generation unit 81 is newly provided.

The restriction information generation unit 81 generates restriction information according to the operation of the terminal 11 by the user, for example, and supplies the restriction information to the transmission unit 43.

Therefore, in FIG. 11, the transmission unit 43 transmits the restriction information from the restriction information generation unit 81 to the server 12, similarly to the biological species list from the biological species list generation unit 41 and the evaluation method information from the evaluation method information generation unit 42.

The restriction information is information that restricts the construction of the interaction network.

As the restriction information, for example, information that restricts one or both of a main biological species to be searched for an interaction and a sub-biological species to be searched for as another biological species that causes an interaction with the main biological species can be employed. For example, information indicating a biological classification of a biological species to be searched for or not to be searched for can be employed as the restriction information.

In the server 12, one or both of the main biological species and the sub-biological species to be searched for are restricted to biological species belonging to the biological classification indicated by the restriction information or biological species other than the biological species belonging to the biological classification indicated by the restriction information.

For example, in a case where the restriction information indicates that the main biological species (biological species constituting the combination) to be searched for an interaction is restricted to the plant species, the biological species (main biological species) used for the combination of the biological species is restricted to the plant species among the biological species registered in the biological species list. In this case, the combination of the biological species is generated using only the plant species among the biological species registered in the biological species list.

Furthermore, for example, in a case where the restriction information indicates that the sub-biological species to be searched for as another biological species that causes an interaction with the main biological species is restricted to biological species other than microbial species, other biological species (sub-biological species) used for constructing the interaction network are restricted to biological species other than the microbial species. In this case, the interaction network is constructed using only the biological species other than the microbial species as the sub-biological species.

In addition, information for restricting the interaction can be employed as the restriction information. For example, information indicating an interaction that is permitted or prohibited to be used for constructing an interaction network can be employed as the restriction information.

An interaction allowed by the restriction information to be used for constructing the interaction network is also referred to as permitted interaction, and an interaction prohibited by the restriction information to be used for constructing the interaction network is also referred to as prohibited interaction.

In the server 12, the interaction used to construct the interaction network is restricted to only the permitted interaction or only the interaction other than the prohibited interaction according to the restriction information.

### <Second Configuration Example of Decision Unit 52>

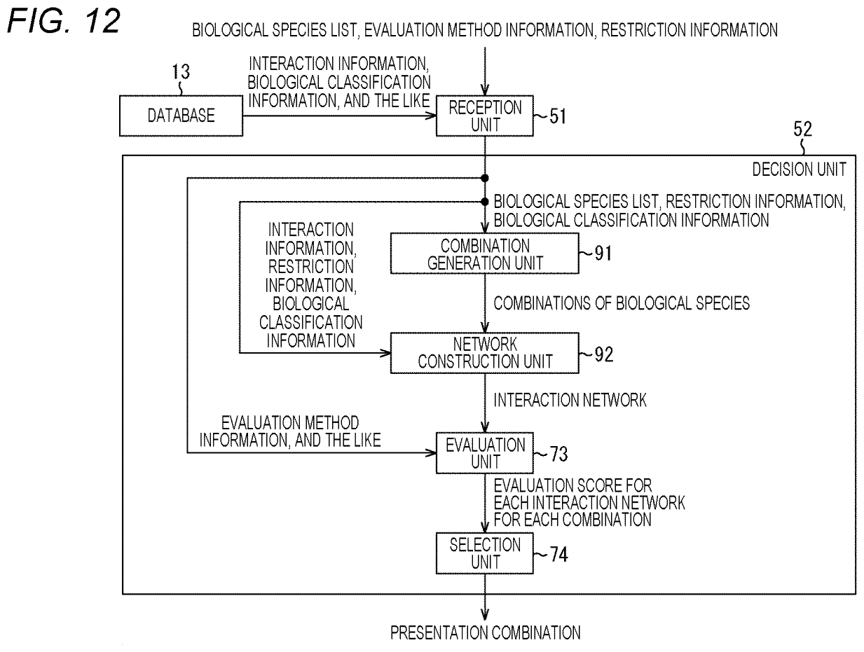

FIG. 12 is a block diagram illustrating a second configuration example of the decision unit 52 in FIG. 6.

FIG. 12 illustrates a configuration example of the decision unit 52 in a case where the terminal 11 is configured as illustrated in FIG. 11.

Note that, in the drawing, portions corresponding to those in the case of FIG. 8 are denoted by the same reference numerals, and the description thereof will be appropriately omitted below.

In FIG. 12, the decision unit 52 includes an evaluation unit 73, a selection unit 74, a combination generation unit 91, and a network construction unit 92.

Therefore, the decision unit 52 of FIG. 12 is common to the case of FIG. 8 in that the evaluation unit 73 and the selection unit 74 are provided. However, the decision unit 52 in FIG. 12 is different from the case of FIG. 8 in that a combination generation unit 91 and a network construction unit 92 are provided instead of the combination generation unit 71 and the network construction unit 72, respectively.

In FIG. 12, in the reception unit 51 of the server 12, not only the biological species list and the evaluation method information are received from the terminal 11, but also the restriction information is received and supplied to the decision unit 52. Moreover, in the reception unit 51, in addition to the interaction information received from the database 13, the biological classification information is received and supplied to the decision unit 52.

The combination generation unit 91 is common to the combination generation unit 71 in generating a combination of biological species from the biological species registered in the biological species list. However, the combination generation unit 91 is different from the combination generation unit 71 in that the main biological species constituting the combination are restricted according to the restriction information.

For example, the combination generation unit 91 recognizes the biological classification of the biological species registered in the biological species list by using the biological classification information. The combination generation unit 91 deletes the biological species belonging to the biological classification indicated by the restriction information or a biological classification other than the biological classification indicated by the restriction information from the biological species list.

The combination generation unit 91 generates a combination of biological species by using the biological species list after deletion obtained by deleting the biological species in the biological classification indicated by the restriction information or the biological classification other than the biological classification indicated by the restriction information, and supplies the combination to the network construction unit 92.

Thus, the main biological species constituting the combination, that is, the target of the search for the interaction in the network construction unit 92 in the subsequent stage is restricted to the biological species belonging to the biological classification other than the biological classification indicated by the restriction information or the biological classification indicated by the restriction information.

Note that an instruction as to whether to delete, from the biological species list, the biological species belonging to the biological classification indicated by the restriction information or the biological species belonging to the biological classification other than the biological classification indicated by the restriction information can be included in the restriction information.

The network construction unit 92 is common with the network construction unit 72 in that, for a combination of the main biological species from the combination generation unit 91, an interaction caused by the main biological species constituting the combination and a sub-biological species that causes an interaction with the main biological species are searched for using the interaction information, and an interaction network is constructed. However, the network construction unit 92 is different from the network construction unit 72 in that the sub-biological species to be searched for are restricted according to the restriction information.

The network construction unit 92 searches for a sub-biological species that causes an interaction with the main biological species constituting the combination, excluding biological species belonging to the biological classification represented by the restriction information or the biological classification other than the biological classification represented by the restriction information.

Thus, the sub-biological species are restricted only to the biological species belonging to the biological classification other than the biological classification indicated by the restriction information or the biological classification indicated by the restriction information.

Note that, in searching for the sub-biological species, an instruction on whether to exclude the biological species belonging to the biological classification indicated by the restriction information or to exclude the biological species belonging to the biological classification other than the biological classification indicated by the restriction information can be included in the restriction information.

After searching for the sub-biological species as described above, the network construction unit 92 constructs an interaction network having the main biological species and the sub-biological species as nodes, and supplies the interaction network to the evaluation unit 73.

As described above, in the server 12, one or both of the main biological species and the sub-biological species to be searched for are restricted according to the restriction information generated according to the operation of the user. Thus, the user can limit the main biological species and the sub-biological species to be searched for according to a plan of construction of the target ecosystem, the situation, the feasibility, the availability of the biological species, and the like. As a result, it is possible to obtain a flexible presentation combination according to operation of the site where the ecosystem is constructed.

For example, by limiting one or both of the main biological species and the sub-biological species to a biological species of a “highly mobile” biological classification (functional classification), it can be expected that an appropriate presentation combination for constructing a biome having high habitat connectivity with the surrounding ecosystem can be obtained.

Note that, in FIG. 12, it is assumed that the restriction information is information that restricts one or both of the main biological species and the sub-biological species to be searched for. However, as the restriction information, information indicating the permitted interaction or the prohibited interaction can be employed as described with reference to FIG. 11.

In a case where the restriction information is information indicating the permitted interaction or the prohibited interaction, in the network construction unit 92, the interaction used for constructing the interaction network is restricted to only the permitted interaction or only interactions other than the prohibited interaction according to the restriction information.

### <Third Configuration Example of Decision Unit 52>

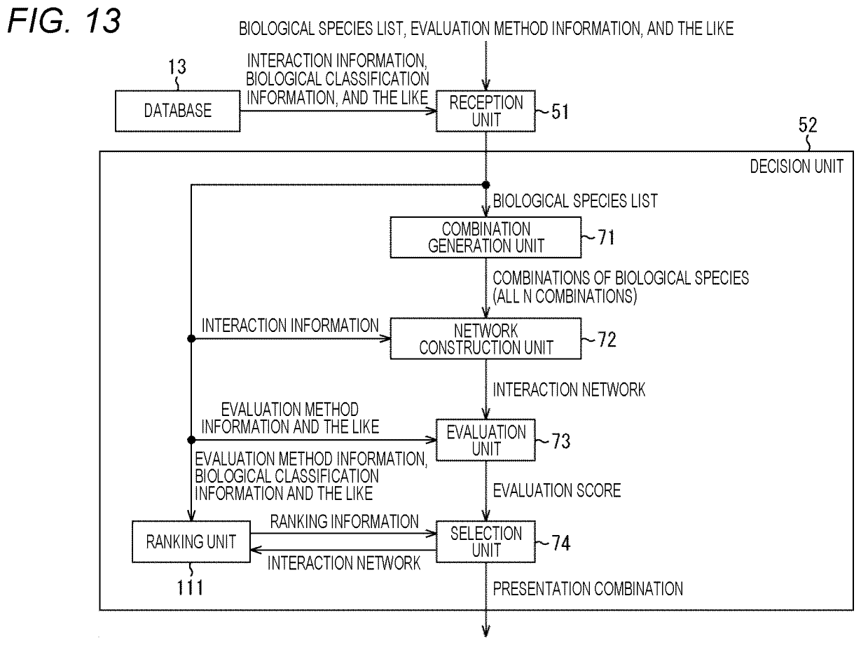

FIG. 13 is a block diagram illustrating a third configuration example of the decision unit 52 in FIG. 6.

Note that, in the drawing, portions corresponding to those in the case of FIG. 8 are denoted by the same reference numerals, and the description thereof will be appropriately omitted below.

In FIG. 13, the decision unit 52 includes the combination generation unit 71 to the selection unit 74, and a ranking unit 111.

Therefore, the decision unit 52 in FIG. 13 is common to the case of FIG. 8 in that the combination generation unit 71 to the selection unit 74 are provided. However, the decision unit 52 of FIG. 13 is different from the case of FIG. 8 in that the ranking unit 111 is newly provided.

In FIG. 13, in the reception unit 51 of the server 12, in addition to the interaction information received from the database 13, the biological classification information is received and supplied to the decision unit 52.

The evaluation method information from the terminal 11 and the biological classification information from the database 13 are supplied from the reception unit 51 to the ranking unit 111, and the interaction network for the presentation combination is supplied from the selection unit 74.

The ranking unit 111 ranks the main biological species constituting the presentation combination according to the interaction network for the presentation combination.

Here, the evaluation method information from the terminal 11 can include information indicating a ranking method for ranking the main biological species constituting the presentation combination together with information indicating the evaluation method for evaluating the interaction network.

The evaluation method information including the information indicating the ranking method can be generated by the evaluation method information generation unit 42 according to, for example, the operation of the terminal 11 by the user.

As the ranking method, for example, a method of ranking the main biological species to be ranked higher as the centricity is higher according to the centricity in the interaction network of the main biological species to be ranked can be employed.

The centricity in the interaction network includes medium centricity, proximity centricity, and order centricity. The order centricity is expressed by the degree of a node, that is, the number of links (directly) connected to the node. The proximity centricity is represented by an average value of distances from the node to each of other nodes. The distance between two nodes is represented by the number of links that pass in a case where the shortest path connecting the two nodes is taken. The medium centricity is represented by a ratio of shortest paths passing through the node of interest among shortest paths connecting two nodes other than the node of interest.

Furthermore, as the ranking method, for example, a method can be employed in which, according to the number of sub-biological species included that cause a specific type of interaction with the main biological species to be ranked, the larger the number, the higher the ranking.

Moreover, as the ranking method, for example, according to the number of sub-biological species of a specific biological classification that causes an interaction with the main biological species to be ranked, a method of ranking higher as the number of the sub-biological species is larger can be employed.

In addition, as the ranking method, for example, a method of ranking according to whether or not a specific interaction occurs directly or indirectly with other biological species of a specific biological classification with the main biological species to be ranked can be employed. For example, according to the number of cases in which an interaction for directly or indirectly suppressing growth occurs with respect to a pathogenic microorganism, a method of ranking the pathogenic microorganism higher as the number is larger can be employed.

In a case of employing the ranking method of performing ranking according to the number of sub-biological species of a specific biological classification that causes an interaction with the main biological species to be ranked, the biological classification information is used to recognize the biological classification of the sub-biological species in the ranking unit 111.

The user can designate a desired ranking method by operating the terminal 11. For example, in a case where the user wants to recognize the importance of the main biological species on the interaction network, the user can designate a ranking method in which the higher the centricity, the higher the ranking according to the centricity in the interaction network.

The ranking unit 111 supplies the selection unit 74 with ranking information indicating the ranking of the main biological species obtained by ranking the main biological species constituting the presentation combination.

The selection unit 74 supplies the ranking information from the ranking unit 111 to the generation unit 53 (FIG. 6) together with the presentation combination.

In this case, the generation unit 53 can generate a presentation UI (hereinafter, it is also referred to as a ranked presentation UI) that presents the presentation combination so that the ranking represented by the ranking information of the main biological species constituting the presentation combination can be recognized.

Note that the ranking method can be set in the server 12 in advance, and the ranking unit 111 can perform the ranking by the ranking method set in the server 12 in advance.

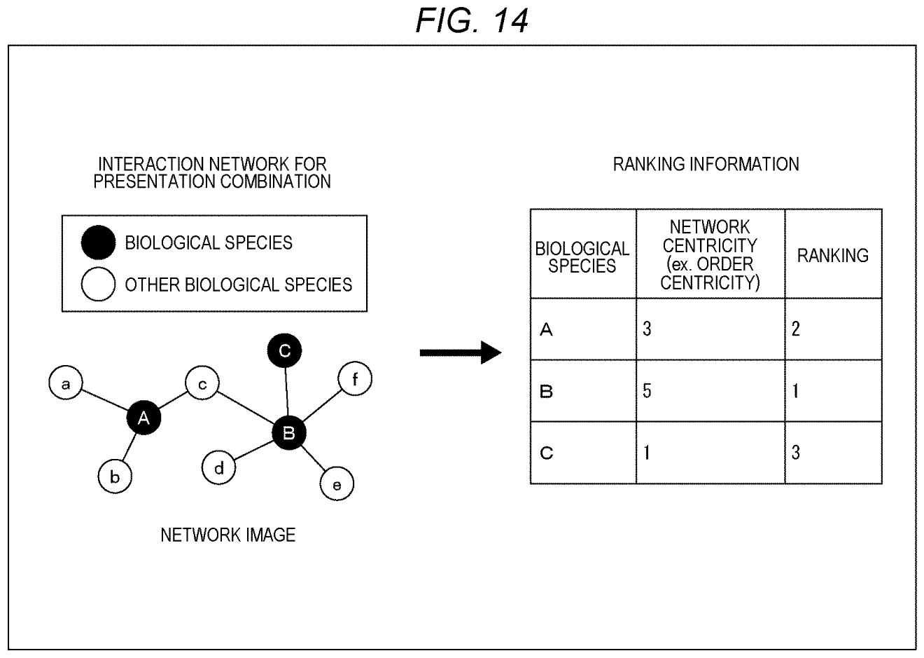

FIG. 14 is a diagram illustrating an example of ranking of the main biological species constituting the presentation combination by the ranking unit 111.

In FIG. 14, the presentation combination is a combination of the main biological species A to C. Furthermore, an interaction network is constructed in which the node of the main biological species A and nodes of the sub-biological species a to c that cause an interaction with the main biological species A are connected by links with respect to the presentation combination. Moreover, an interaction network has been constructed in which the node of the main biological species B and each of the nodes of the sub-biological species c to f and C that cause an interaction with the main biological species B are connected by links.

In FIG. 14, ranking is performed according to order centricity in the interaction network, and main biological species A to C constituting the presentation combination are ranked.

The order centricity of the main biological species A to C, that is, the number of connected links is three, five, and one, respectively, and the order of the main biological species B is first, the order of the main biological species A is second, and the order of the main biological species C is third in the descending order of the number of links.

As the ranked presentation UI, for example, a network image that presents an interaction network for a presentation combination and an image that presents the ranking of the main biological species as illustrated in FIG. 14 can be employed.

In addition, as the ranked presentation UI, for example, an image or the like in which the main biological species are ranked in the vicinity of the node of the main biological species in the interaction network for the presentation combination can be employed.

The ranked presentation UI is transmitted from the transmission unit 54 to the terminal 11 and displayed, whereby the user can recognize, for example, the importance, effectiveness, and the like of the main biological species in constructing the target ecosystem. Then, the user can determine an action to be performed in constructing the ecosystem and confirm the appropriateness of the action (management) performed in constructing the ecosystem according to the importance or the like of the main biological species.

For example, in a case where the number of main biological species constituting the presentation combination, that is, the number of appropriate main biological species to be introduced for constructing the target ecosystem is large, and it is difficult to introduce all the main biological species constituting the presentation combination from the viewpoint of the budget or the like, the main biological species to be introduced can be decided in descending order of ranking within a range falling within the budget. Alternatively, it can be decided that the number of individuals to be introduced is increased as the main biological species is higher in order.

Furthermore, for example, in a case where a part of the main biological species constituting the presentation combination has already been introduced, if the order of the already introduced main biological species is high, it can be confirmed that the introduction of the main biological species is more appropriate.

### <Presentation UI>

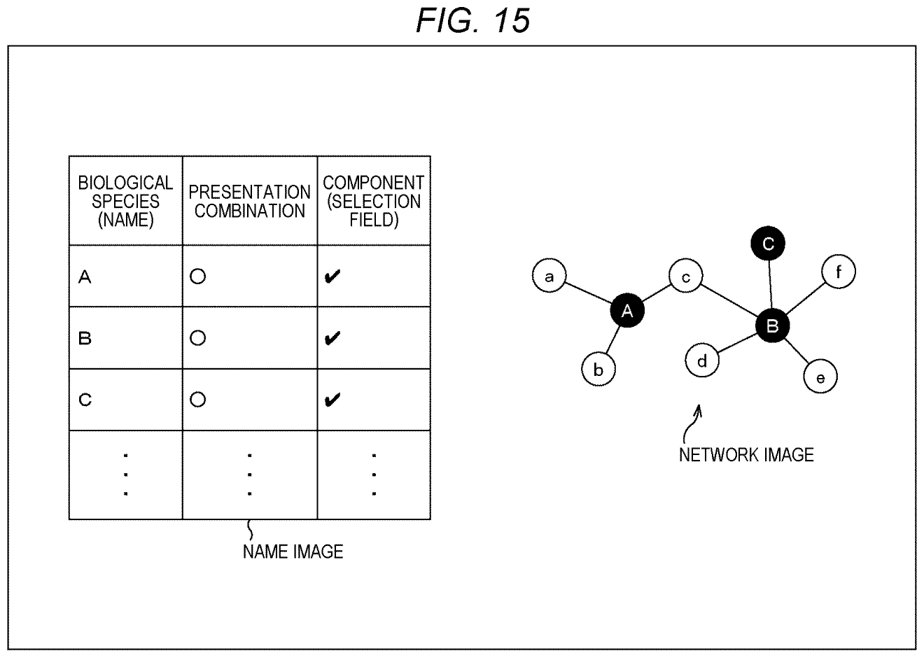

FIG. 15 is a diagram illustrating a display example of the presentation UI.

FIG. 15 illustrates a name image and a network image as the presentation UI.

In the name image, the names of the species registered in the biological species list are listed in the vertical direction, and a circle is given to the species constituting the presentation combination. Moreover, in the name image, a selection field for selecting a biological species to be a component of the interaction network is provided.

As the selection field, for example, a UI such as a check box, a radio button, a toggle switch, or the like can be employed. In FIG. 15, a check box is employed as a selection field, and a biological species that is a component of the interaction network is checked.

A network image is an image of an interaction network constructed for a presentation combination. In FIG. 15, combinations of the biological species A to C are presentation combinations, and a network image of interaction networks constructed for such presentation combinations is displayed.

In the interaction network, the node of the main biological species A and the nodes of the sub-biological species a to c that cause an interaction with the main biological species A are connected by links. Moreover, the node of the main biological species B and the nodes of the sub-biological species c to f and C that cause an interaction with the main biological species B are connected by links.

For the presentation UI, a biological species selection operation, a filtering operation, a clustering operation, and the like can be performed.

The selection operation of the biological species is, for example, an operation of individually selecting or non-selecting the biological species to be a component of the presentation combination by adding or deleting a check to or from the check box.

The filtering operation is an operation for collectively selecting biological species having specific attributes such as a tree in a case of selecting a biological species to be a component of the presentation combination. The filtering operation can include an operation instructing to add or remove a biological species of the attribute selected in the filtering operation to or from components of the presentation combination.

For example, when the user performs a filtering operation to remove the biological species of the attribute of the tree, the network image of the interaction network for the combination of the biological species obtained by excluding the biological species of the attribute of the tree from the presentation combination is presented in the presentation UI.

The clustering operation is an operation for clustering and presenting a biological species of a specific attribute in the presentation UI. For example, when the user designates a tree as a specific attribute and performs the clustering operation, a biological species of a tree is presented in a color (for example, red, or the like) different from other biological species in the presentation UI.

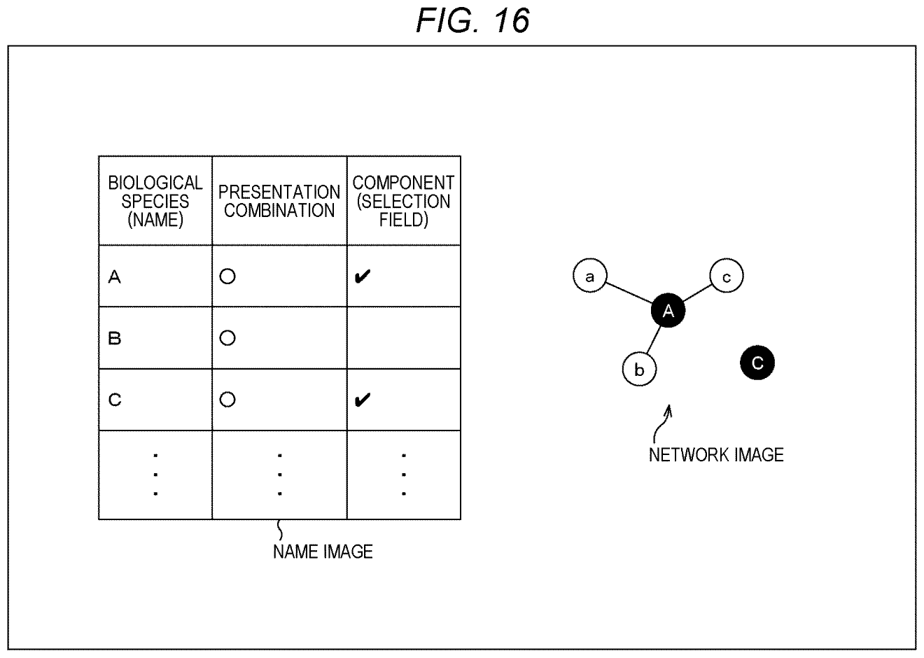

FIG. 16 is a diagram illustrating a display example of the presentation UI displayed in a case where an operation on the presentation UI is performed.

In a case where the user performs an operation on the presentation combination presented in the presentation UI, in the server 12, the interaction network for the presentation combination after the operation is reconstructed according to the operation. Then, a presentation UI that presents the reconstructed interaction network (the presentation combination after the operation) is generated, transmitted from the server 12 to the terminal 11, and displayed.

FIG. 16 illustrates a display example of the presentation UI presenting the interaction network after the reconstruction displayed as described above.

In other words, FIG. 16 illustrates a presentation UI that presents an interaction network after reconstruction in a case where a selection operation for deselecting the biological species B being a component of the presentation combination is performed for the presentation combination presented in the presentation UI of FIG. 15.

In the presentation UI of FIG. 16, the biological species B in the name image is unchecked in response to the selection operation for deselecting the biological species B.

Moreover, in the presentation UI of FIG. 16, a network image of the interaction network reconstructed for the combination of the biological species A and C, which is the presentation combination after the selection operation, is presented.

As described above, the interaction network for the presentation combination after the operation is reconstructed according to the user's operation on the presentation combination presented in the presentation UI. Then, the presentation UI that presents the reconstructed interaction network is generated and displayed.

Therefore, the user can interactively change the biological species constituting the presentation combination and confirm the interaction network for the changed presentation combination. As a result, it is possible to help the user to understand the matter expressed by the interaction network, for example, an interaction that occurs directly or indirectly with a biological species, a biological species on which the interaction is directly or indirectly exerted, or the like.

Furthermore, for example, the user can compare a presentation UI in a case where the combination of the biological species A to C in FIG. 15 is a presentation combination with a presentation UI in a case where the biological species B in FIG. 16 is not included in the presentation combination. This makes it possible to accurately understand the impact in a case where the biological species B is introduced or not introduced.

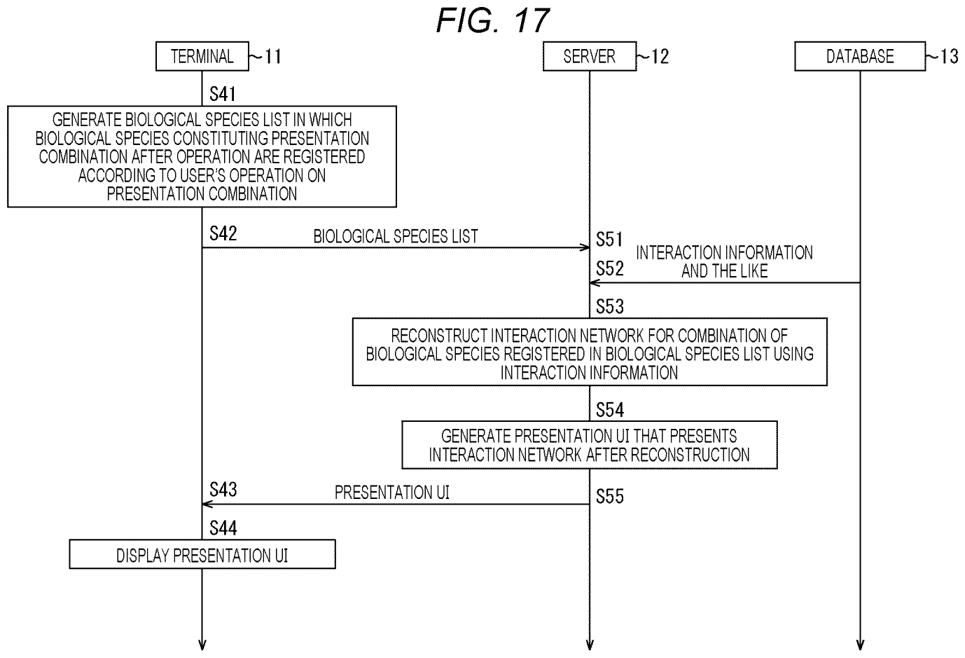

FIG. 17 is a diagram illustrating an example of processing of an information processing system 10 performed according to the user's operation on the presentation combination presented by the presentation UI.

In the terminal 11 (FIG. 5) (FIG. 11), in step S41, the biological species list generation unit 41 generates a biological species list in which biological species constituting the presentation combination after operation are registered according to the user's operation on the presentation combination presented in the presentation UI, and supplies the biological species list to the transmission unit 43.

In step S42, the transmission unit 43 transmits the biological species list to the server 12.

In the server 12 (FIG. 6), in step S51, the reception unit 51 receives the biological species list transmitted from the terminal 11 and supplies the biological species list to the decision unit 52.

In step S52, as in step S22 of FIG. 7, the reception unit 51 accesses the database 13, receives necessary information such as interaction information, and supplies the information to the decision unit 52.

In step S53, the decision unit 52 reconstructs the interaction network with respect to a combination having a biological species registered in the biological species list as a component, that is, a presentation combination after the operation of the user, and supplies the reconstructed interaction network to the generation unit 53.

In step S54, the generation unit 53 generates a new presentation UI including a network image of the interaction network for the presentation combination after the operation, that is, the interaction network after the reconstruction from the decision unit 52 as the presentation UI that presents the presentation combination after the operation of the user, and supplies the new presentation UI to the transmission unit 54.

In step S55, the transmission unit 54 transmits the new presentation UI to the terminal 11.

In the terminal 11, in step S43, the reception unit 44 receives the new presentation UI transmitted from the server 12 and supplies the presentation UI to the display control unit 45.

In step S44, the display control unit 45 causes the display unit 46 to display the image as the new presentation UI, that is, the name image of the presentation combination after the operation of the user and the network image of the interaction network for the presentation combination.

In the information processing system 10, the above processing is performed every time an operation is performed on the presentation combination presented by the presentation UI.

Therefore, every time the user performs an operation on the presentation combination presented in the presentation UI, the interaction network for the presentation combination after the operation is reconstructed, and the presentation UI that presents the interaction network and the like after the reconstruction is displayed.

Thus, the user can interactively confirm the interaction network after the change of a biological species to be a component of the presentation combination.

### <Second Example of Processing of Information Processing System 10>

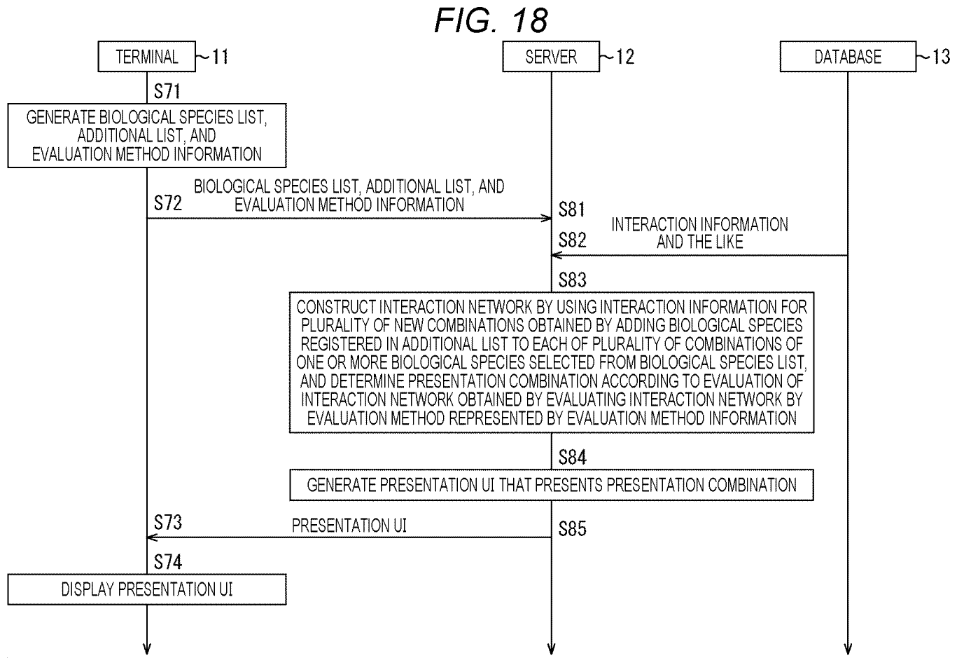

FIG. 18 is a diagram illustrating a second example of processing of the information processing system 10.

In the terminal 11 (FIG. 5) (FIG. 11), in step S71, the biological species list generation unit 41 generates a biological species list according to an operation of the user, and the evaluation method information generation unit 42 generates the evaluation method information, as in step S11 in FIG. 7.

Moreover, in step S71, the biological species list generation unit 41 generates an additional list according to an operation or the like of the user.

The additional list is a list in which biological species to be added to a plurality of combinations of biological species selected from the biological species list are registered, and for example, similarly to the biological species list, the biological species list generation unit 41 generates the additional list according to the user's operation.

The user can designate any biological species as the biological species to be registered in the additional list by operating the terminal 11. For example, the user can designate a biological species existing in the same place, such as a biological species existing in a growth place where a target ecosystem is constructed or to be constructed, as a biological species to be registered in the additional list.

Furthermore, a sensor that senses a biological species such as a camera is mounted on the terminal 11, and a growth place or the like can be sensed by the sensor. In this case, the biological species list generation unit 41 of the terminal 11 can recognize a biological species existing in the growth place and generate an additional list in which the biological species are registered by performing processing such as image recognition on the sensing result of the sensor.

In a case where the additional list is used, for example, the user can operate the terminal 11 so that a species to be introduced into the growth place is registered in the biological species list and a species existing in the growth place is registered in the additional list.

The biological species list and the additional list generated by the biological species list generation unit 41 and the evaluation method information generated by the evaluation method information generation unit 42 are supplied to the transmission unit 43.

In step S72, the transmission unit 43 transmits the biological species list, the additional list, and the evaluation method information to the server 12.

In the server 12 (FIG. 6), in step S81, the reception unit 51 receives the biological species list, the additional list, and the evaluation method information transmitted from the terminal 11, and supplies them to the decision unit 52.

In step S82, as in step S22 of FIG. 7, the reception unit 51 accesses the database 13, receives necessary information such as interaction information, and supplies the information to the decision unit 52.

In step S83, the decision unit 52 generates a plurality of combinations of biological species by selecting a biological species from the plurality of biological species registered in the biological species list. Then, the decision unit 52 generates a plurality of additional combinations of biological species by adding the biological species registered in the additional list to each of the plurality of combinations of biological species.

Note that, in a case where the additional list exists, the combination of the biological species generated from the biological species list can include a combination of zero biological species, that is, a combination of empty sets. In this case, the additional combination is a combination of only the biological species registered in the additional list.

Using the interaction information, the decision unit 52 constructs, for each of a plurality of additional combinations of biological species, an interaction network including, as nodes, a main biological species constituting the additional combination and a sub-biological species that causes an interaction with the main biological species.

The decision unit 52 evaluates the interaction network by the evaluation method indicated by the evaluation method information, decides a presentation combination from a plurality of additional combinations according to the evaluation, and supplies the presentation combination to the generation unit 53.

Note that the decision unit 52 can determine the additional combination as the presentation combination, or can determine a combination obtained by removing the biological species registered in the additional list from the additional combination, that is, a combination generated from the biological species list, as the presentation combination.

Thereafter, in steps S84 and S85, the server 12 performs processes similar to those in steps S24 and S25 in FIG. 7.

Furthermore, in steps S73 and S74, the terminal 11 performs processes similar to those in steps S13 and S14 in FIG. 7.

As described above, the terminal 11 displays the presentation UI that presents the presentation combination decided from the plurality of additional combinations obtained by adding the biological species registered in the additional list to the plurality of combinations of the biological species selected from the plurality of biological species registered in the biological species list.

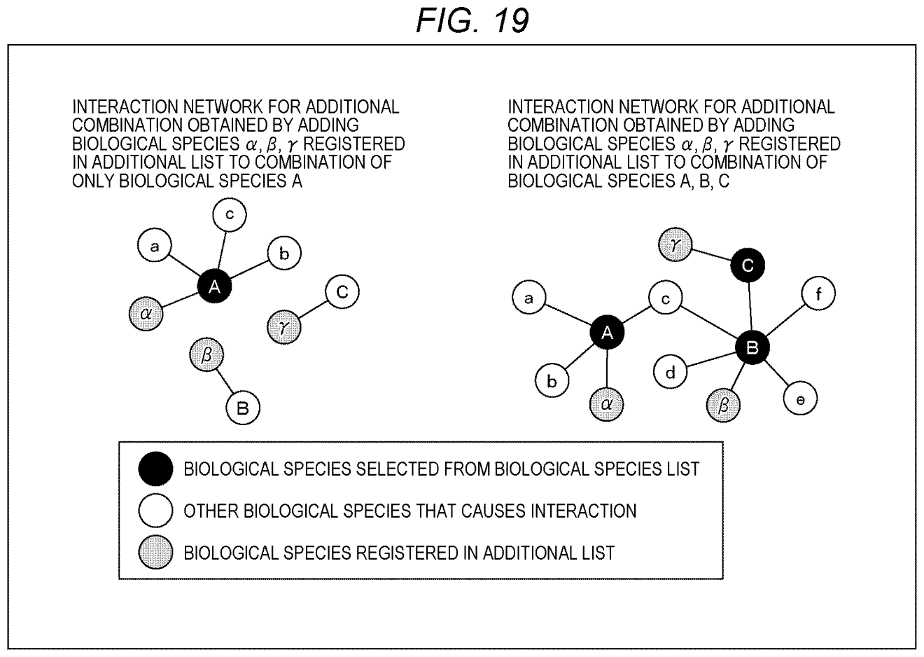

FIG. 19 is a diagram illustrating an example of an interaction network for an additional combination obtained by adding a species registered in the additional list to a combination of species selected from the plurality of biological species registered in the biological species list.

For example, it is assumed that three biological species A to C are registered in the biological species list, and three species α to γ are registered in the additional list.

FIG. 19 illustrates an interaction network for each of the two additional combinations.

The first additional combination is a combination obtained by adding the three biological species α to γ registered in the additional list to a combination of only one biological species A registered in the biological species list.

Here, in addition to the biological species constituting the combination of the biological species selected from the biological species registered in the biological species list, the biological species constituting the additional combination obtained by adding the biological species registered in the additional list to the combination are also referred to as main biological species as appropriate.

In the interaction network for the first additional combination, the node of the main biological species A and each of nodes of sub-biological species a to c and α that cause an interaction with the main biological species A are connected by links.

Moreover, the node of the main biological species β and the node of the sub-biological species B that causes an interaction with the main biological species β are connected by a link, and the node of the main biological species γ and the node of the sub-biological species C that causes an interaction with the main biological species γ are connected by a link.

In FIG. 19, the node of the biological species registered in the additional list is represented by a shaded circle.

The biological species B and C that are sub-biological species in the interaction network for the first additional combination are also the biological species (main biological species) registered in the biological species list.

The second additional combination is a combination obtained by adding the three biological species α to γ registered in the additional list to a combination of three biological species A to C registered in the biological species list.

In the interaction network for the second additional combination, the node of the main biological species A and each of the nodes of the sub-biological species a to c and a that cause interaction between the main biological species A are connected by links.

Moreover, the node of the main biological species B and the nodes of the sub-biological species c to f, C, and β that interact with the main biological species B are connected by links, and the node of the main biological species C and the node of the sub-biological species γ that causes an interaction with the main biological species C are connected by a link.

As described above, a plurality of additional combinations obtained by adding the biological species registered in the additional list to the combination of the biological species selected from the plurality of biological species registered in the biological species list is generated. Then, a presentation combination is decided from the plurality of additional combinations according to the evaluation of the interaction network.

In this case, the presentation combination can include a biological species registered in the additional list.

Therefore, for example, in a case where there is a biological species that the user strongly desires to be introduced into the growth place, the presentation combination including the biological species that the user strongly desires to be introduced is provided by registering the biological species in the additional list. As a result, it is possible to construct an ecosystem in which the biological species strongly desired to be introduced by the user is introduced.

Furthermore, for example, a biological species existing in the growth place is registered in the additional list, thereby providing a presentation combination including the biological species existing in the growth place. As a result, it is possible to construct an ecosystem in which the current state of the growth place, for example, biological species such as plants and microbiome existing in the land and space as the growth place are utilized as much as possible.

### <Third Example of Processing of Information Processing System 10>

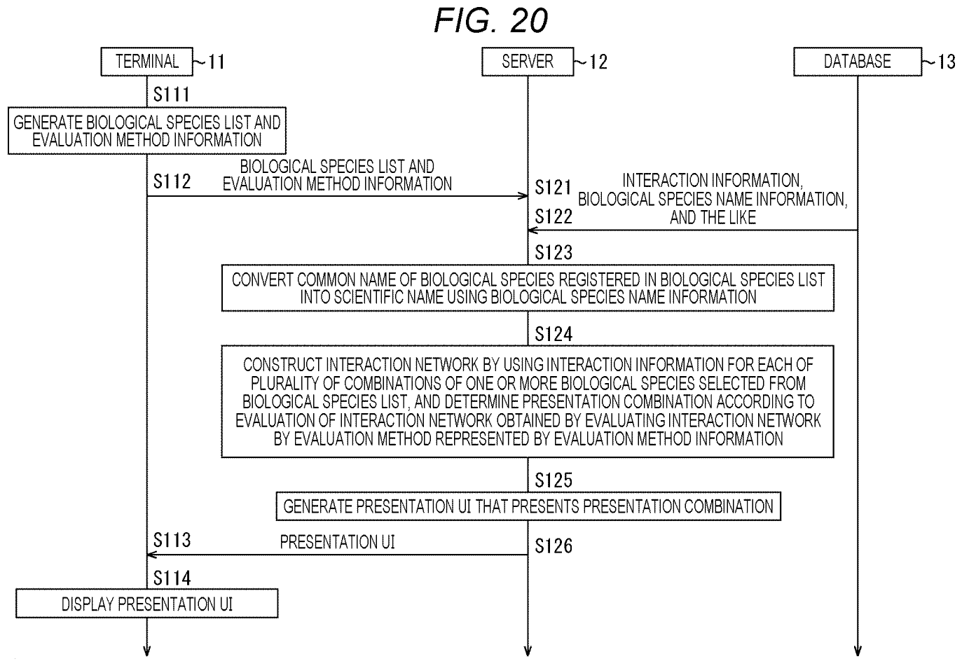

FIG. 20 is a diagram illustrating a third example of processing of the information processing system 10.

In steps S111 and S112 and step S121, processes similar to those in steps S11 and S12 and step S21 in FIG. 7 are performed.

In step S122, in the server 12 (FIG. 6), the reception unit 51 accesses the database 13, receives necessary information such as the interaction information, and supplies the information to the decision unit 52.

Here, the information received by the reception unit 51 from the database 13 in step S22 in FIG. 7 includes at least the interaction information.

On the other hand, the information received by the reception unit 51 from the database 13 in step S122 includes at least biological species name information in addition to the interaction information. The biological species name information received by the reception unit 51 from the database 13 in step S122 is biological species name information including a common name at least in a case where there is a biological species registered with the common name in the biological species list.

In step S123, in a case where there is a biological species registered with a common name in the biological species list, the decision unit 52 converts the common name into a scientific name using the biological species name information.

Thereafter, in steps S124 to S126 and steps S113 and S114, processes similar to those in steps S23 to S25 and steps S13 and S14 in FIG. 7 are performed.

Since the scientific name is a name given to a classification group of organisms in common in the world, the scientific name is used for describing information regarding a biological species such as interaction information stored in the database 13.

On the other hand, a user who is not an expert rarely knows the scientific name as the name of the biological species (biological species name), and for example, uses a rough common name (general name) such as “apple”.

Therefore, as described with reference to FIG. 20, in a case where there is a biological species registered in the biological species list with a common name, by converting the common name into a scientific name using the biological species name information, the user can input the biological species registered in the biological species list with the common name.

Therefore, it is possible to improve convenience in a case where the user operates the terminal 11 to input the biological species registered in the biological species list.

Note that, in the presentation combination presented in the presentation UI, the common name and the scientific name can be written together as the name of the biological species. In this case, the user can learn the scientific name of the biological species.

Here, in the present embodiment, not a scientific name but a common name is appropriately used to describe the name of the biological species for easy understanding of the description.

### <Fourth Example of Processing of Information Processing System 10>

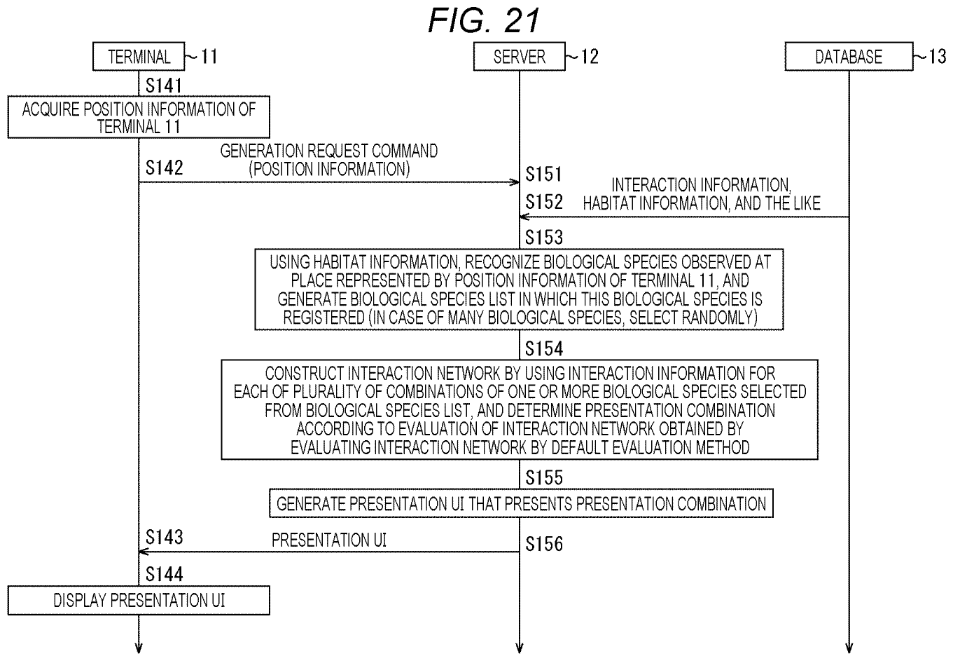

FIG. 21 is a diagram illustrating a fourth example of processing of the information processing system 10.

In the terminal 11 (FIG. 5) (FIG. 11), in step S141, the transmission unit 43 acquires the position information of the terminal 11 from the positioning unit 25 (FIG. 2), for example, according to the operation of the terminal 11 by the user.

In step S142, the transmission unit 43 includes a generation request command for requesting generation of a biological species list in the position information of the terminal 11 and transmits it to the server 12.

In the server 12 (FIG. 6), in step S151, the reception unit 51 receives the generation request command transmitted from the terminal 11, and supplies the generation request command to the decision unit 52.

In step S152, the reception unit 51 accesses the database 13, receives necessary information such as the interaction information, and supplies the information to the decision unit 52.

Here, the information received by the reception unit 51 from the database 13 in step S22 in FIG. 7 includes at least the interaction information.

On the other hand, the information received by the reception unit 51 from the database 13 in step S152 includes at least habitat information in addition to the interaction information. The habitat information received by the reception unit 51 from the database 13 in step S152 is at least habitat information regarding a habitat including a position indicated by the position information included in the generation request command from the terminal 11.

In step S153, using the habitat information, the decision unit 52 recognizes a biological species observed with the place of the position indicated by the position information from the terminal 11 as a habitat, that is, a biological species that inhabits the place of the position indicated by the position information from the terminal 11.

Then, the decision unit 52 generates a biological species list in which biological species that inhabit the place of the position indicated by the position information from the terminal 11 are registered.

In this case, for example, a biological species observed at the place, such as a plant species having an observation example as natural vegetation at the place of the position indicated by the position information from the terminal 11, is registered in the biological species list.

Note that, in addition, in the decision unit 52, it is possible to recognize a biological species suitable for the environment such as the climate of the place although it is not observed (although it does not inhabit) at the place of the position indicated by the position information from the terminal 11. Then, this biological species can also be treated as a biological species observed at the place of the position indicated by the position information from the terminal 11 in a pseudo manner. The biological species suitable for the environment such as the climate of the place of the position indicated by the position information from the terminal 11 is, for example, a biological species observed at another place in an environment similar to the place of the position indicated by the position information from the terminal 11.

In a case where the number of biological species observed at the place of the position indicated by the position information from the terminal 11 is large, the load on the server 12 increases, and thus the decision unit 52 can limit the number of biological species to be registered in the biological species list.

In a case where the number of biological species observed at the place of the position indicated by the position information from the terminal 11 is larger than a preset threshold value, the decision unit 52 can limit the number of biological species to be registered in the biological species list as follows.

For example, the decision unit 52 can randomly select a number of biological species equal to the threshold value from the biological species observed at the place of the position indicated by the position information from the terminal 11 and register the selected biological species in the biological species list.

Furthermore, for example, the decision unit 52 can select a number of biological species equal to or less than the threshold value from the biological species of one or more specific biological classifications in the biological species observed at the place of the position indicated by the position information from the terminal 11 and register the selected biological species in the biological species list.

In addition, for example, the decision unit 52 can select the same number of biological species from the biological species of each biological classification in the biological species observed at the place of the position indicated by the position information from the terminal 11 such that the total number is equal to or less than the threshold value, and register the selected biological species in the biological species list.

In step S154, the decision unit 52 generates a plurality of combinations of biological species by selecting a biological species from a plurality of biological species registered in the biological species list. Moreover, the decision unit 52 constructs, for each of the plurality of combinations of biological species, an interaction network including, as nodes, a main biological species constituting the combination and a sub-biological species that causes an interaction with the main biological species by using the interaction information.

The decision unit 52 evaluates the interaction network by a default evaluation method set in advance in the server 12, decides a presentation combination according to the evaluation, and supplies the presentation combination to the generation unit 53.

In step S155, the generation unit 53 generates a presentation UI that presents the presentation combination from the decision unit 52, and supplies the presentation UI to the transmission unit 54.

In FIG. 21, the presentation UI generated by the generation unit 53 can include an attention calling message for calling attention that the biological species list (automatically) generated by the server 12 is used instead of the biological species list in which the biological species designated by the user is registered.

By presenting the attention calling message in the presentation UI, it is possible to prevent the user from misunderstanding that the presentation combination presented in the presentation UI is a combination obtained by using the biological species list in which the biological species designated by the user are registered.

Thereafter, in step S156 and steps S143 and S144, processes similar to those in step S25 and steps S13 and S14 in FIG. 7 are performed.

As described above, in the server 12, generating the biological species list (in which the biological species and the like observed at the place of the position indicated by the position information from the terminal 11 are registered) is also referred to as automatic generation of the biological species list.

In a case where the automatic generation of the biological species list is performed, the user does not need to operate the terminal 11 to designate the biological species, and thus the automatic generation of the biological species list is useful, for example, in a case where a user who is not familiar with biological species tries a sense of use of the terminal 11.

In addition, the automatic generation of the biological species list is useful in a case where a demonstration of displaying a presentation UI that presents a presentation combination is performed, a case where the user desires the automatic generation of the biological species list due to a reason that the operation of the terminal 11 is troublesome, or the like.

Note that, in FIG. 21, the evaluation of the interaction network is performed by the default evaluation method, but the evaluation of the interaction network can be performed by the evaluation method indicated by the evaluation method information generated according to the operation of the terminal 11 by the user, as in the case of FIG. 7 and the like.

Furthermore, in FIG. 21, the position information indicating the position of the terminal 11 is employed as the position information to be included in the generation request command, but for example, position information of any place such as a place designated by the user operating the terminal 11 can be included in the generation request command.

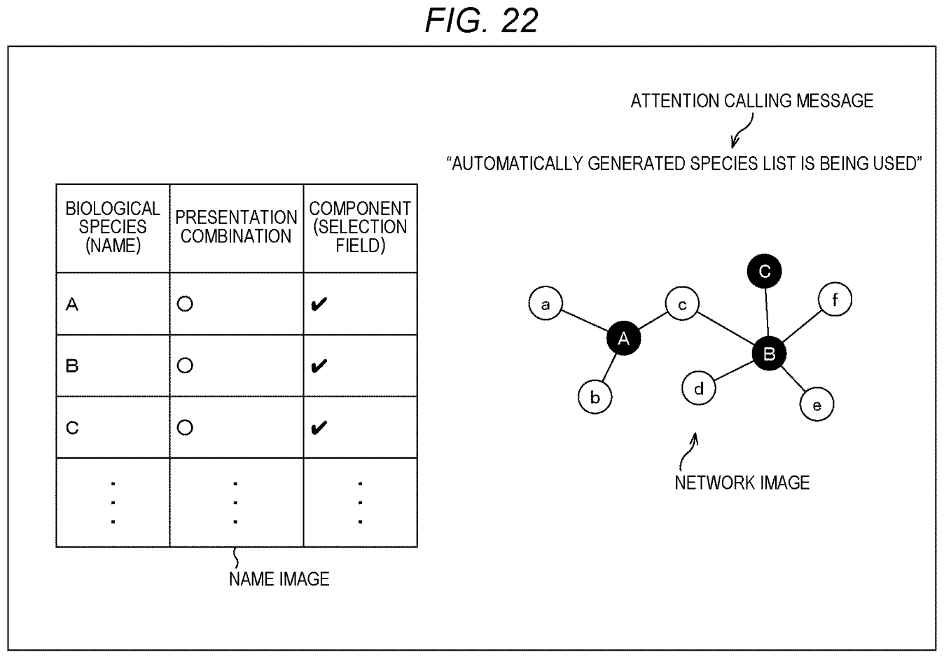

FIG. 22 is a diagram illustrating a display example of the presentation UI in a case where the biological species list is automatically generated.

In the presentation UI in a case where the automatic generation of the biological species list is performed, for example, an attention calling message for calling attention that the automatic generation of the biological species list has been performed is displayed together with the name image and the network image described in FIG. 15.

In FIG. 22, a message “an automatically generated biological species list is being used” is displayed as the attention calling message.

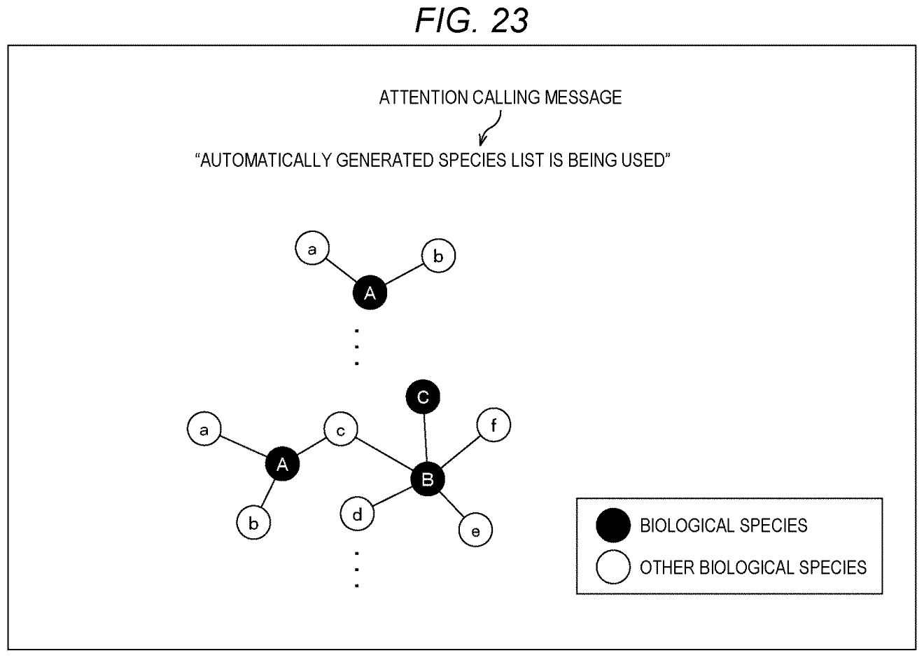

FIG. 23 is a diagram illustrating another display example of the presentation UI.

In the presentation UI, in addition to the network image of the interaction network for the presentation combination, the network image of the interaction network for other combinations generated from the biological species list may be displayed.

In FIG. 23, network images of interaction networks for each of all combinations generated from the biological species list are displayed.

In the presentation UI, in addition to the network image of the interaction network for the presentation combination, the network image of the interaction network for other combinations may also be displayed. Also in this case, when the biological species list is automatically generated, the attention calling message can be displayed.

### <Update of Database 13>

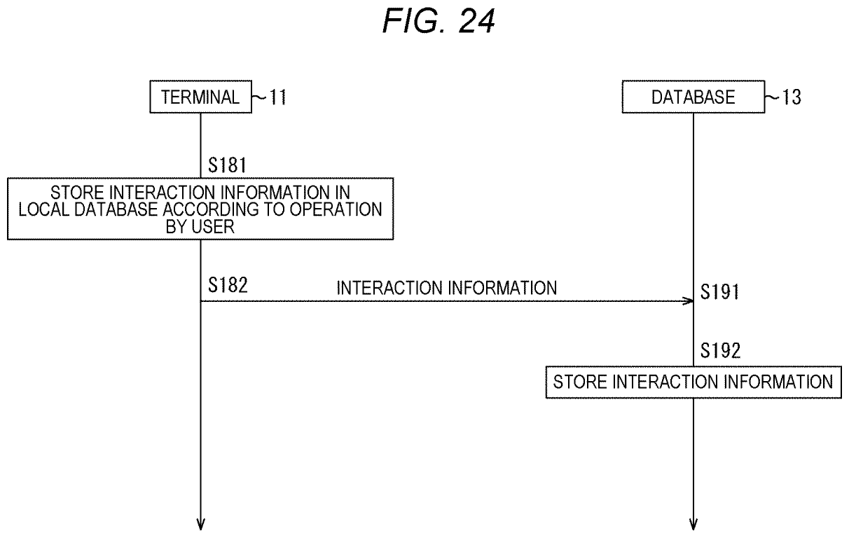

FIG. 24 is a diagram for describing processing of updating the interaction information of the database 13 performed by the information processing system 10.

The database 13 can be updated in response to an input from a user (external).

In the terminal 11, in step S181, the interaction information is stored in a local database (not illustrated) according to the operation of the terminal 11 by the user.

Here, the interaction may be disclosed in a paper and visible to the user. Furthermore, a user may discover an interaction from an analysis result of metagenomic analysis of a microbiome or the like that can be performed at low cost in recent years. Moreover, in daily life or the like, the user may observe an interaction such as a certain insect preying on another insect.

In a case of contacting an interaction as described above, the user can input the interaction information regarding the interaction by operating the terminal 11.

In step S181, the interaction information input by the user operating the terminal 11 is stored in the local database.

In step S182, the terminal 11 transmits, to the database 13, the interaction information that has not yet been transmitted to the database 13 among the interaction information stored in the local database.

In the database 13, in step S191, the interaction information from the terminal 11 is received.

In step S192, the database 13 additionally stores the interaction information from the terminal 11, thereby updating the stored content.

Only the interaction information initially stored in the database 13 may not store exhaustive interaction information.

Therefore, as described above, the interaction information of the database 13 can be updated (reinforced) by additionally storing the interaction information input by the user operating the terminal 11.

Thus, the user participation type development, that is, the user participation type database 13 is constructed, and the robust and highly scalable collective intelligence type database 13 can be constructed. In such a user participation type database 13, the database 13 itself may have value as a research target.

### <Fourth Configuration Example of Decision Unit 52>

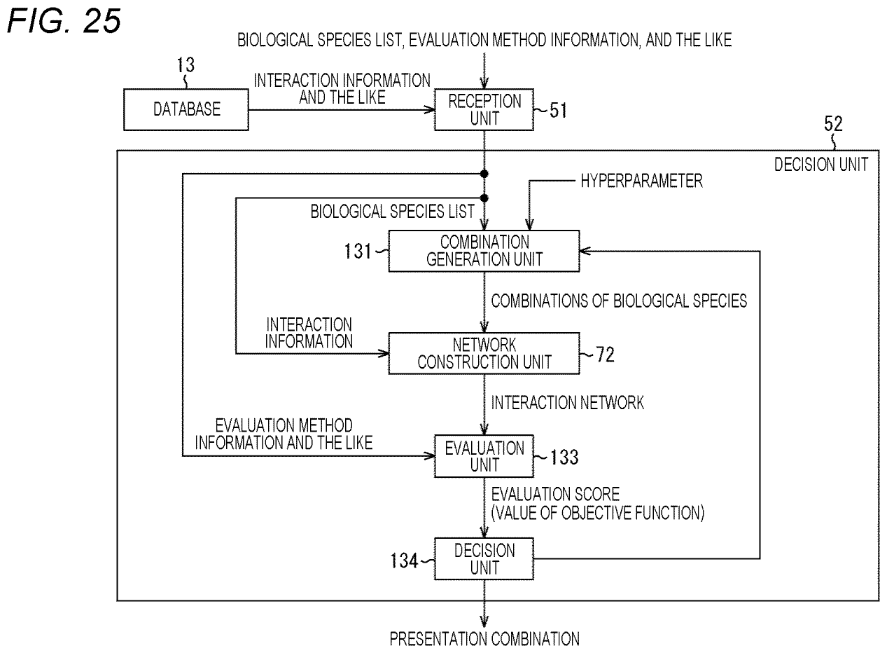

FIG. 25 is a block diagram illustrating a fourth configuration example of the decision unit 52 in FIG. 6.

Note that, in the drawing, portions corresponding to those in the case of FIG. 8 are denoted by the same reference numerals, and the description thereof will be appropriately omitted below.

In FIG. 25, the decision unit 52 includes the network construction unit 72, a combination generation unit 131, an evaluation unit 133, and a determination unit 134.

Therefore, the decision unit 52 in FIG. 25 is common to the case of FIG. 8 in that the network construction unit 72 is provided. However, the decision unit 52 in FIG. 25 is different from the case of FIG. 8 in that the combination generation unit 131, the evaluation unit 133, and the determination unit 134 are provided instead of the combination generation unit 71, the evaluation unit 73, and the selection unit 74, respectively.

In the decision unit 52 in FIGS. 8, 12, and 13, all combinations of biological species (optionally including a combination of empty sets as necessary) of the biological species registered in the biological species list are generated.

Then, an interaction network is constructed and evaluated for each of all combinations of biological species, and a combination having the best evaluation score is decided as a presentation combination.

In a case where all combinations are generated, if there are many biological species registered in the biological species list, the number of combinations of the biological species becomes enormous. In this case, in the server 12, it may be difficult to construct and evaluate the interaction network for the enormous number of combinations using limited calculation resources.

Therefore, the decision unit 52 can determine the presentation combination by solving the combination optimization problem by an approximate solution. In this case, construction of the interaction network and the number of combinations of biological species to be evaluated can be suppressed, and calculation resources can be saved.

Note that, in a case where the combination optimization problem is solved by an approximate solution, a combination used for calculation of an objective function is set by a heuristic algorithm when finding a combination that maximizes/minimizes the objective function under necessary constraint conditions.

In the present technology, the objective function can be set by the evaluation method indicated by the evaluation method information. As the objective function, for example, the calculation formula of the evaluation score described in FIG. 8 can be employed.

Furthermore, in the present technology, the constraint condition is not essential. Whether or not to use the constraint condition and the content of the constraint condition in the case of using the constraint condition can be set, for example, according to the user's operation. For example, whether or not to use the constraint condition and the content of the constraint condition in the case of using the constraint condition can be included in the evaluation method information and transmitted from the terminal 11 to the server 12.

For example, in order to secure a certain degree of high biological diversity, it is possible to employ, as the constraint condition, that X or more kinds of biological species are included in the combination of the biological species, or the like.

In FIG. 25, the biological species list is supplied from the reception unit 51 to the combination generation unit 131. Moreover, a hyperparameter for setting the behavior of the approximate solution is supplied to the combination generation unit 131.

Here, the hyperparameter is a parameter for setting behavior of an algorithm for generating (deciding) a combination of biological species, and does not include information of the objective function. This is because the objective function is set according to the evaluation method information.

Furthermore, the hyperparameter can be set in the server 12 in advance, or can be set according to a user's operation. In a case where the hyperparameter is set according to the user's operation, the hyperparameter can be transmitted from the terminal 11 to the server 12 together with, for example, the biological species list.

The combination generation unit 131 generates a combination of biological species (main biological species) to be searched for interaction from the biological species registered in the biological species list.

That is, the combination generation unit 131 generates a combination of biological species on the basis of the previous combination of biological species (previously generated combination) supplied from the determination unit 134 according to an algorithm of a metaheuristic approximate solution determined according to hyperparameters.

As the algorithm of the metaheuristic approximate solution, for example, a local search method, simulated annealing, a genetic algorithm, tabu search, or the like can be employed.

Note that, in a case where the combination of biological species is first generated from the biological species registered in the biological species list in the combination generation unit 131, the combination of biological species can be generated by any method such as randomly selecting a random number of biological species from the biological species registered in the biological species list.

The combination of the biological species generated by the combination generation unit 131 is supplied to the network construction unit 72.

Using the interaction information, the network construction unit 72 constructs an interaction network for the combination of the biological species from the combination generation unit 131, and supplies the interaction network to the evaluation unit 133.

The evaluation unit 133 is supplied with the interaction network for the combination of biological species from the network construction unit 72, and is supplied with the evaluation method information from the reception unit 51.

The evaluation unit 133 sets a calculation formula of an evaluation score as an objective function according to the evaluation method information. The evaluation unit 133 calculates the evaluation score (the value of the objective function) of the interaction network from the network construction unit 72 according to the calculation formula, and supplies the evaluation score to the determination unit 134.

The determination unit 134 determines an evaluation score of the interaction network from the evaluation unit 133.

The determination unit 134 determines whether the evaluation score of the interaction network for the current combination (the combination of the biological species generated this time) from the evaluation unit 133 has deteriorated or improved in comparison with the evaluation score of the interaction network for the previous combination.

In a case of determining that the evaluation score of the interaction network for the current combination has been improved, the determination unit 134 feeds back (supplies) the current combination to the combination generation unit 131.

In this case, the combination generation unit 131 selects a biological species from the biological species list on the basis of the current combination fed back from the determination unit 134 according to the algorithm of the metaheuristic approximate solution, and generates a new combination. Then, the combination generation unit 131 supplies the new combination to the network construction unit 72.

On the other hand, in a case of determining that the evaluation score of the interaction network for the current combination has deteriorated, the determination unit 134 decides the previous combination as a presentation combination as the approximate solution of the combination optimization problem and supplies the presentation combination to the generation unit 53 (FIG. 6).

### <Fifth Example of Processing of Information Processing System 10>

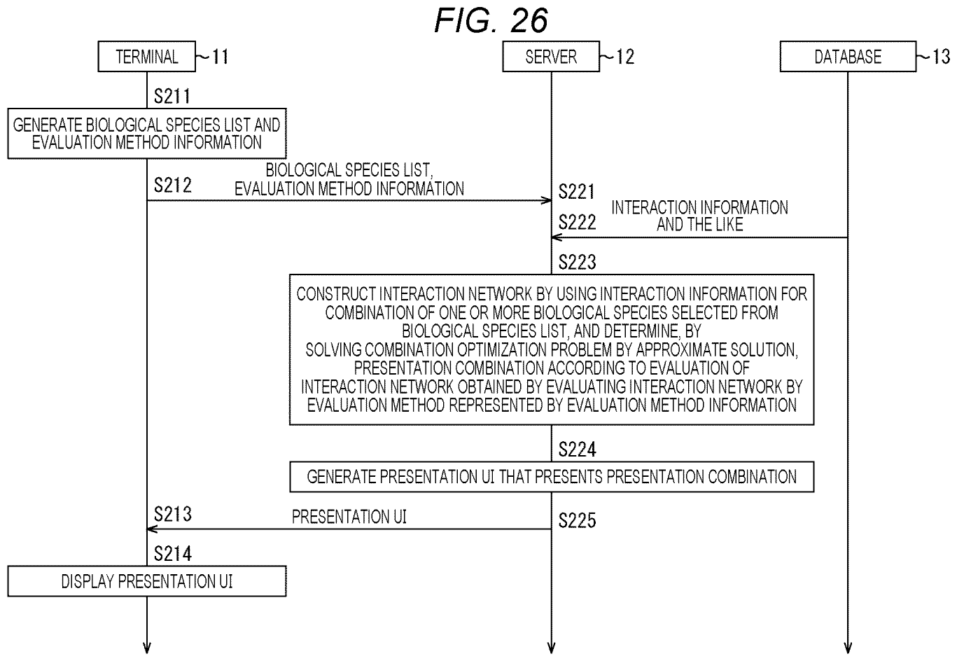

FIG. 26 is a diagram illustrating a fifth example of processing of the information processing system 10.

In other words, FIG. 26 illustrates an example of processing of the information processing system 10 in a case where the decision unit 52 is configured as illustrated in FIG. 25 and decides the presentation combination by solving the combination optimization problem by an approximate solution.

In the terminal 11, in steps S211 to S214, processes similar to those in steps S11 to S14 in FIG. 7 are performed.

In the server 12, in steps S221, S222, S224, and S225, processes similar to those in steps S21, S22, S24, and S25 in FIG. 7 are performed.

Furthermore, in the server 12, in step S223, the decision unit 52 decides a presentation combination by solving the combination optimization problem by the approximate solution, and supplies the presentation combination to the generation unit 53.

That is, in the decision unit 52 (FIG. 25), the combination generation unit 131 selects a biological species from the biological species list according to the algorithm of the metaheuristic approximate solution, generates a combination of the biological species, and supplies the combination to the network construction unit 72.

Using the interaction information, the network construction unit 72 constructs an interaction network for the combination of the biological species from the combination generation unit 131, and supplies the interaction network to the evaluation unit 133.

The evaluation unit 133 calculates an evaluation score (value of the objective function) of the interaction network from the network construction unit 72 according to the calculation formula of the evaluation score as the objective function set according to the evaluation method information, and supplies the evaluation score to the determination unit 134.

The determination unit 134 determines whether the evaluation score of the interaction network for the current combination from the evaluation unit 133 has deteriorated or improved in comparison with the evaluation score of the interaction network for the previous combination.

In a case where the evaluation score of the interaction network for the current combination is improved, the determination unit 134 feeds back the current combination to the combination generation unit 131.

The combination generation unit 131 selects a biological species from the biological species list on the basis of the current combination fed back from the determination unit 134 according to the algorithm of the metaheuristic approximate solution, and generates a new combination.

Hereinafter, the decision unit 52 repeats similar processing until the evaluation score of the interaction network for the current combination deteriorates.

Then, in a case where the evaluation score of the interaction network for the current combination deteriorates, the determination unit 134 decides the previous combination as a presentation combination as the approximate solution of the combination optimization problem, and supplies the presentation combination to the generation unit 53.

As described above, the decision unit 52 solves the combination optimization problem by the approximate solution to determine the presentation combination, thereby saving calculation resources and suppressing acquisition of an inappropriate combination of biological species as the presentation combination.

Hereinafter, a specific example of determination of the presentation combination in the decision unit 52 will be described. Note that, in the following, in order to simplify the description, all combinations of biological species are generated from the biological species list.

### <Specific Example of Determination of Presentation Combination>

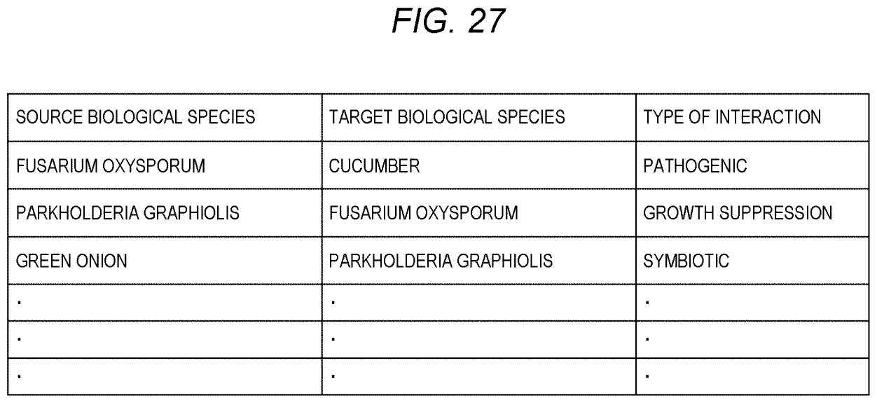

FIG. 27 is a diagram illustrating interaction information used in a first specific example of deciding the presentation combination.

In the interaction information of FIG. 27, an interaction is associated with a target biological species on which the interaction is exerted and the original source biological species that exerts the interaction on the target biological species.

According to the interaction of FIG. 27, for example, Fusarium oxysporum exerts a pathogenic interaction on cucumber. Furthermore, for example, Parkholderia graphiolis exerts a growth inhibitory interaction on Fusarium oxysporum, and green onion exerts a symbiotic interaction on Parkholderia graphiolis.

In the first specific example, an ecosystem that minimizes the infection risk of pathogenic microorganisms targeting the plant species while improving the species diversity of the plant species is set as a target ecosystem, and a combination of plant species appropriate for construction of the target ecosystem is specified from a plurality of plant species.

In the first specific example, for example, the user operates the terminal 11 so that the higher the species diversity of the plant species, the higher the evaluation, and the higher the infection risk of the pathogenic microorganisms, the lower the evaluation. The evaluation method information generation unit 42 generates the evaluation method information according to the operation of the terminal 11.

In the decision unit 52, the calculation formula of the evaluation score is set as, for example, Formula (1) according to the evaluation method information.

$$Evaluation score = plant species diversity score + influence degree score \qquad ( 1 )$$

The plant species diversity score represents the species diversity of the plant species constituting the interaction network, and is set to a higher score as the number of plant species increases according to the plant species constituting the interaction network. For example, as the plant species diversity score, the number of plant species constituting the interaction network can be employed.

The influence degree score represents the degree to which the plant species constituting the interaction network affect the infection risk of pathogenic microorganisms. For example, the influence degree score is set to a smaller value, for example, a negative value having a larger absolute value, as a penalty as the degree of influence of the plant species to increase the infection risk of the pathogenic microorganism is larger. Furthermore, the influence degree score is set to a larger value, for example, a positive value having a larger absolute value as a reward as the degree of influence of the plant species to lower the infection risk of the pathogenic microorganism is larger.

For example, it is assumed that the user schedules rape, cucumber, green onion, and Robinia pseudoacacia as possibilities of plant species to be introduced into the ecosystem.

In this case, the user operates the terminal 11 to input an instruction to generate the biological species list and (the names of) rape, cucumber, green onion, and Robinia pseudoacacia. The biological species list generation unit 41 generates a biological species list in which rape, cucumber, green onion, and Robinia pseudoacacia are registered according to the operation of the terminal 11.

In the decision unit 52, by selecting a biological species from the biological species list, a combination of the biological species is generated. Moreover, in the decision unit 52, an interaction network is constructed for a combination of biological species by using the interaction information.

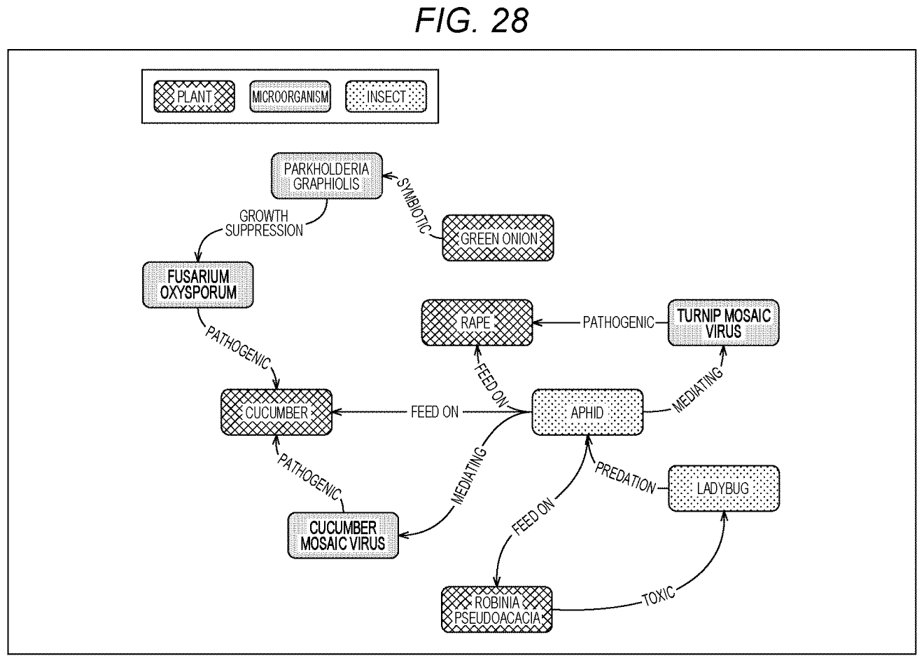

FIG. 28 is a diagram illustrating an interaction network constructed for a combination of four biological species of rape, cucumber, green onion, and Robinia pseudoacacia.

In the decision unit 52, by using the interaction information of FIG. 27, a sub-biological species that causes an interaction with each of the main biological species of rape, cucumber, green onion, and Robinia pseudoacacia (portions with mesh pattern in the drawing) constituting a combination of four biological species is searched for. In FIG. 28, microbial species (shaded portions in the drawing) and insects (portions with dot pattern in the drawing) are searched for as sub-biological species.

In FIG. 28, for example, Fusarium oxysporum and cucumber mosaic virus are searched for as sub-biological species that cause interaction with cucumber among main biological species constituting a combination of four biological species.

Furthermore, for example, Parkholderia graphiolis has been searched for as a sub-biological species that causes an interaction with green onion.

The main biological species constituting the combination of the four biological species and the sub-biological species interacting with the main biological species become nodes of an interaction network for the combination of the four biological species.

In the decision unit 52, after searching for the sub-biological species that cause interaction with each of the main biological species, the interaction that occurs between any two biological species of all biological species of the main biological species and the sub-biological species is searched for using the interaction information of FIG. 27.

In FIG. 28, for example, an interaction of growth suppression occurring between Parkholderia graphiolis and Fusarium oxysporum, an interaction of predation occurring between ladybugs and aphids, and the like are searched.

In the decision unit 52, an interaction network is constructed by connecting nodes that generate an interaction among nodes of the biological species (main biological species and sub-biological species) with arrows as links.

Among the biological species represented by the nodes of the interaction network, for example, the pathogenic interaction from Fusarium oxysporum is exerted on cucumber as illustrated in the interaction information of FIG. 27.

Therefore, in the interaction network, a node of cucumber and a node of Fusarium oxysporum are connected (linked) by an arrow in a direction corresponding to the interaction as a link representing pathogenicity.

The arrow as the link representing pathogenicity is an arrow in a direction starting at the node of the original Fusarium oxysporum that exerts a pathogenic interaction and ending at the node of the cucumber as a target on which the pathogenic interaction is exerted.

Furthermore, among the biological species represented by the nodes of the interaction network, for example, green onion exerts a symbiotic interaction on Parkholderia graphiolis as illustrated in the interaction information of FIG. 27.

Therefore, in the interaction network, a node of the green onion and a node of the Parkholderia graphiolis are connected by an arrow as a link representing symbiosis with the node of the green onion as a start point and the node of the Parkholderia graphiolis as an end point.

Furthermore, among the biological species represented by the nodes of the interaction network, for example, Parkholderia graphiolis exerts an interaction for growth suppression on Fusarium oxysporum as illustrated in the interaction information of FIG. 27.

Therefore, in the interaction network, a node of Parkholderia graphiolis and a node of Fusarium oxysporum are connected by an arrow as a link representing growth suppression with the node of Parkholderia graphiolis as a start point and the node of Fusarium oxysporum as an end point.

Note that, in the interaction network of FIG. 28, Robinia pseudoacacia is supposed to exert a toxic interaction directly on the ladybugs. However, in practice, substances that are produced by Robinia pseudoacacia and are toxic to ladybugs are taken up by the ladybugs via aphids preyed on by the ladybugs.

That is, when aphids feed on Robinia pseudoacacia and ladybugs prey on the aphids, the ladybugs take in a toxic substance produced by Robinia pseudoacacia.

After constructing the interaction network, the decision unit 52 evaluates the interaction network. The evaluation of the interaction network is performed by calculating an evaluation score according to the calculation formula of Formula (1) set according to the evaluation method information.

In order to calculate the influence degree score of the calculation formula of Formula (1), the decision unit 52 specifies a pathogenic microorganisms (pathogenic microbial species) from (the biological species serving as a node of) the interaction network.

For the interaction network of FIG. 28, three of Fusarium oxysporum, turnip mosaic virus, and cucumber mosaic virus are specified as pathogenic microorganisms (portion illustrated in bold in the drawing).

In the interaction network, the decision unit 52 moves each plant species that is the main biological species in a direction of an arrow representing a link with the node of the plant species as a start point. Then, the decision unit 52 searches for a path that leads to the node of the pathogenic microorganism as an interaction path in which the interaction of the plant species affects the pathogenic microorganism.

That is, the decision unit 52 searches for, as an interaction path, a path that does not pass through the same node a plurality of times with a node of the plant species as a start point and a node of the pathogenic microorganism on which the interaction of the plant species directly or indirectly affects as an end point.

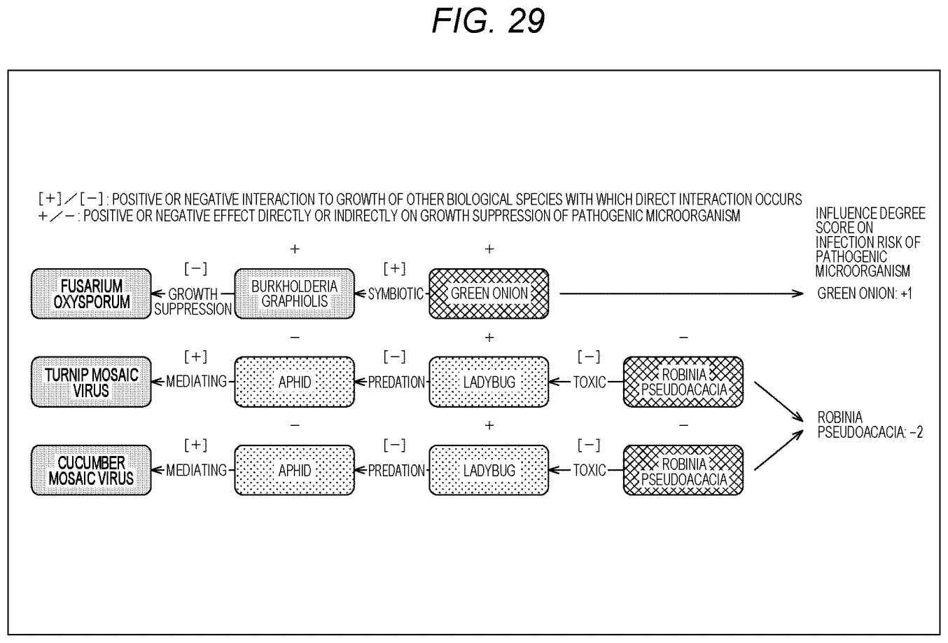

FIG. 29 is a diagram illustrating interaction paths searched for from the interaction network of FIG. 28.

As for the interaction network in FIG. 28, for the green onion which is a plant species, the first interaction path (from the top) that leads to Fusarium oxysporum which is a pathogenic microorganism from the node of the green onion via the node of Parkholderia graphiolis is searched.

Moreover, for Robinia pseudoacacia which is a plant species, the second and third interaction paths reaching the respective nodes of the turnip mosaic virus and the cucumber mosaic virus from the node of Robinia pseudoacacia via the nodes of ladybugs and aphids are searched.

Note that, in the interaction network of FIG. 28, for rape and cucumber which are plant species, the interaction occurring with the pathogenic microorganism is passive, and for rape and cucumber, there is no interaction path (interaction path in which the interaction of rape and cucumber affects pathogenic microorganisms) starting from each of them.

The decision unit 52 calculates the influence degree score according to whether or not the plant species at the start point finally exhibits a positive or negative effect on the pathogenic microorganism at the end point in each interaction path for each plant species.

The decision unit 52 specifies whether the biological species represented by each node other than the end point in the interaction path causes a positive or negative interaction in the growth of the target biological species on which the interaction is directly exerted (the other biological species with which a direct interaction occurs).

Here, an interaction positive for growth is also referred to as a positive action, and an interaction negative for growth is also referred to as a negative action. In FIG. 29, [+] is attached to an arrow indicating a positive action, and [−] is attached to an arrow indicating a negative action.

The decision unit 52 specifies whether or not the biological species of each node other than the end point finally exhibits a positive or negative effect on the growth suppression of the pathogenic microorganism at the node of the end point according to the positive action and the negative action between the node of the end point of the interaction path and each node.

Here, a positive effect and a negative effect for suppressing the growth of pathogenic microorganisms are also referred to as a positive effect and a negative effect, respectively. In FIG. 29, + is attached to a node having a positive effect, and − is attached to a node having a negative effect.

In a case where the plant species of the node of the start point of the interaction path exhibits a positive effect, the decision unit 52 calculates, for example, +1 as the influence degree score of the interaction path. Furthermore, in a case where the plant species of the node of the start point of the interaction path exhibits a negative effect, the decision unit 52 calculates, for example, −1 as the influence degree score of the interaction path.

The decision unit 52 calculates the influence degree score of each plant species by summing the influence degree scores of the interaction paths for the plant species.

In FIG. 29, in the first interaction path for green onion, Parkholderia graphiolis exerts a negative effect ([−]) on growth suppression on the Fusarium oxysporum (of the node) of the end point.

Therefore, Parkholderia graphiolis exhibits a positive effect (+) for suppressing the growth of Fusarium oxysporum.

Furthermore, in the first interaction path for the green onion, the green onion exerts a symbiotic positive effect ([+]) on the Parkholderia graphiolis exhibiting a positive effect (+).

Therefore, the green onion exhibits a positive effect (+) on the growth suppression of Fusarium oxysporum.

As described above, in the first interaction path for the green onion, the green onion at the node of the start point exhibits a positive effect (+), and thus +1 is calculated as the influence degree score of the first interaction path for the green onion.

Since only the first interaction path exists as the interaction path for the green onion, +1 equal to the influence degree score of the first interaction path is calculated as the influence degree score of the green onion.

Next, in FIG. 29, in the second interaction path for Robinia pseudoacacia, aphids exert a mediating positive effect ([+]) on the endpoint turnip mosaic virus. Therefore, in the aphids, the turnip mosaic virus exhibits a negative effect (−) on the growth suppression of the turnip mosaic virus.

Furthermore, in the second interaction path for Robinia pseudoacacia, ladybugs exert a negative effect of predation ([−]) on aphids that exert a negative effect (−).

Therefore, the ladybugs exhibit a positive effect (+) on the growth suppression of the turnip mosaic virus.

Moreover, in the second interaction path for Robinia pseudoacacia, it exerts a negative toxic effect ([−]) on the ladybugs that exert a positive effect (+).

Therefore, Robinia pseudoacacia exhibits a negative effect (−) on the growth suppression of turnip mosaic virus.

As described above, in the second interaction path for Robinia pseudoacacia, since Robinia pseudoacacia at the node of the start point exhibits a negative effect (−), the influence degree score of the second interaction path for Robinia pseudoacacia is calculated to be −1.

In FIG. 29, in the third interaction path for Robinia pseudoacacia, −1 is calculated as the influence degree score, similarly to the second interaction path.

Since the second and third interaction paths exist as the interaction path for Robinia pseudoacacia, as the influence degree score of Robinia pseudoacacia, −2=−1−1 obtained by adding the influence degree scores of the second and third interaction paths is calculated.

Note that, as described above, since there is no interaction path for rape and cucumber, the influence degree score of each of rape and cucumber is 0.

The decision unit 52 calculates the influence degree score of each main biological species and calculates a final influence degree score by summing the influence degree scores.

For the interaction network in FIG. 28, −1=0+0+1−2 is calculated as the final influence degree score by summing the respective influence degree scores of the main biological species of rape, cucumber, green onion, and Robinia pseudoacacia.

The decision unit 52 calculates the plant species diversity score together with the influence degree score of the calculation formula of Formula (1). For example, the number of plant species in the interaction network of FIG. 28, 4, is calculated as the plant species diversity score.

The decision unit 52 calculates an evaluation score of the interaction network according to Formula (1). For example, as the evaluation score of the interaction network in FIG. 28, 3 (=4−1) obtained by adding the influence degree score −1 and the plant species diversity score 4 described above is calculated.

The decision unit 52 calculates the evaluation score of the interaction network for each of all combinations of the biological species selected from the biological species list as described above.

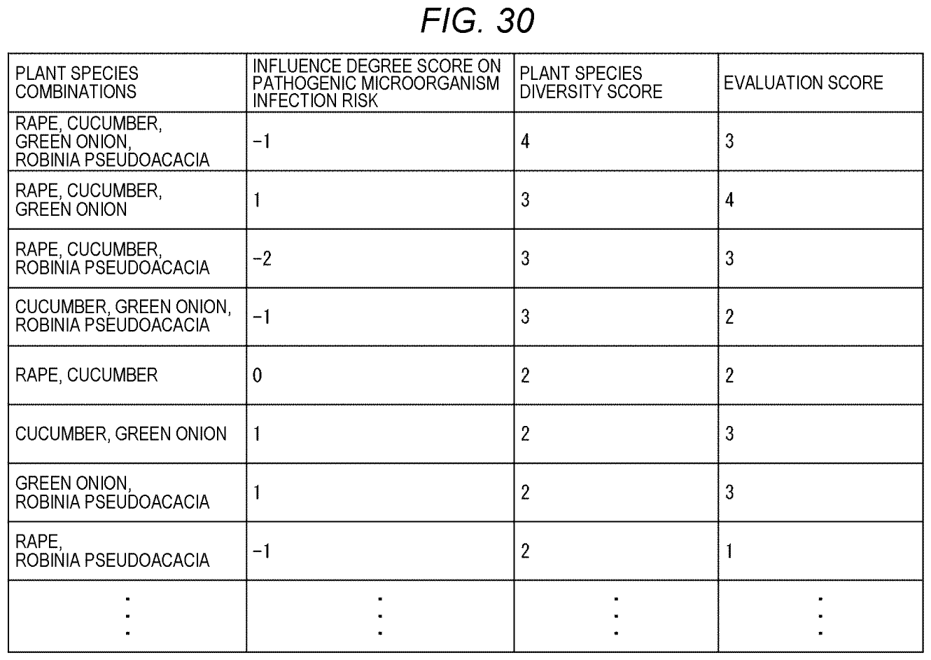

FIG. 30 is a diagram illustrating evaluation scores of an interaction network for each of all combinations of plant species generated from a biological species list in which rape, cucumber, green onion, and Robinia pseudoacacia are registered.

In FIG. 30, each combination of plant species, the evaluation score of the interaction network for the combination, and the plant species diversity score and the influence degree score used for calculating the evaluation score are illustrated.

In FIG. 30, for example, the influence degree score, the plant species diversity score, and the evaluation score of the interaction network with respect to the combination of rape, cucumber, green onion, and Robinia pseudoacacia are illustrated in the first place (from the top).

As described in FIGS. 27 to 29, the influence degree score, the plant species diversity score, and the evaluation score of the interaction network for the combination of rape, cucumber, green onion, and Robinia pseudoacacia are −1, 4, and 3, respectively.

The decision unit 52 decides the combination of the biological species having the best evaluation score of the interaction network as the presentation combination.

In FIG. 30, the evaluation score of the interaction network for the second indicated combination of rape, cucumber, and green onion is 4, which is the best, and thus the combination of rape, cucumber, and green onion is decided as the presentation combination. With the presentation of the presentation combination, the user can recognize that rape, cucumber, and green onion among rape, cucumber, green onion, and Robinia pseudoacacia as possibilities of plant species to be introduced should be introduced in constructing an ecosystem that reduces the infection risk of pathogenic microorganisms while improving the species diversity of plant species.

Note that, here, as illustrated in Formula (1), the addition value of the plant species diversity score and the influence degree score is used as the evaluation score, but as the evaluation score, for example, only the plant species diversity score or only the influence degree score can be used.

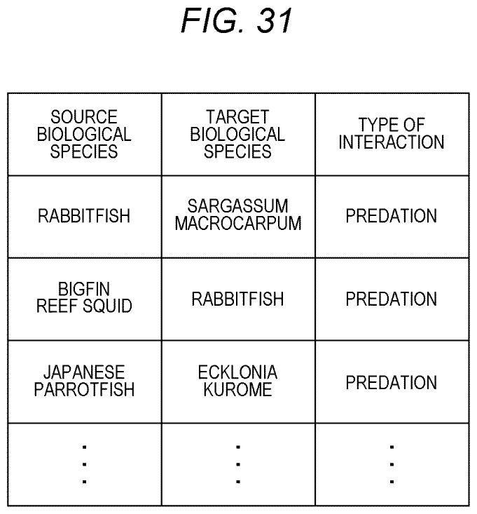

FIG. 31 is a diagram illustrating interaction information used in a second specific example of decision of a presentation combination.

In the interaction information of FIG. 31, the interaction of predation (prey), the target biological species on which the interaction is exerted, and the original source biological species that causes an interaction with the target biological species are associated with each other.

According to the interaction of FIG. 31, for example, the rabbitfish feeds on Sargassum macrocarpum. Furthermore, the bigfin reef squids prey on the rabbitfish, and the Japanese parrotfish feeds on Ecklonia kurome.

In various parts of the world, many cases have been reported in which seaweeds are not grown due to excessive feeding by plant-eating animals (herbivores). The environment in which seaweeds have stopped growing is called “isoyakeba (withered seashore)”.

In recent years, attention has been focused on a treatment for increasing the number of predators of herbivores as one of measures management for isoyakeba. For example, there is a case where the growth of seaweeds has recovered by increasing the number of spiny lobsters, which are predators of sea urchins, which are herbivoids.

This case is a case where only the interaction between spiny lobsters and sea urchins, in which spiny lobsters prey on sea urchins, which are herbivoids, is taken into consideration, but by applying the present technology, it is possible to perform management of measures against isoyakeba comprehensively considering the predation (prey) relationship between various biological species.

In a second specific example, for the purpose of enhancing the biological diversity by introducing marine algae into a specific marine area, an appropriate combination of animal species to coexist for improving the efficiency of fixing of marine algae is specified from a plurality of animal species.

In the second specific example, it is assumed that, for example, Sargassum macrocarpum, Ecklonia kurome, and Gelidium amansii are employed as marine algae to be introduced to enhance the biological diversity of a specific marine area. Moreover, in a specific marine area, for example, Japanese parrotfish, brassy chub, purple sea urchin, and octopus are observed.

Here, marine algae to be introduced into a specific marine area are also referred to as introduced algae, and animal species observed in the specific marine area are also referred to as observed animal species.

In the second specific example, for example, the user operates the terminal 11 to search for the interaction information in FIG. 31, thereby specifying the introduced algae and the related animal species that are the animal species (animals) related to the food web including the observed animal species.

For example, the user specifies an animal species that preys on the introduced algae (Sargassum macrocarpum, Ecklonia kurome, and Gelidium amansii) or the observed animal species (Japanese parrotfish, brassy chub, purple sea urchin, and octopus) as the related animal species. Moreover, for example, the user specifies animal species other than the observed animal species that prey (directly or indirectly) on the introduced algae or the observed animal species as the related animal species.

Here, it is assumed that, for example, bigfin reef squids, rabbitfish, moray eel, spiny lobster, and striped beakfish are specified as the related animal species.

In a particular marine area, the observed animal species already exists. Therefore, in the second specific example, an appropriate combination of related animal species is specified according to the evaluation of the interaction network for the additional combination obtained by adding all of the observed animal species to the combination of zero or more of the related animal species.

Therefore, the user operates the terminal 11 to input an instruction to generate the biological species list and (the name of) the related animal species. In the biological species list generation unit 41, a biological species list in which related animal species are registered is generated according to the operation of the terminal 11.

Moreover, the user operates the terminal 11 to input an instruction to generate the additional list and the observed animal species. The biological species list generation unit 41 generates an additional list in which the observed animal species are registered according to the operation of the terminal 11.

Furthermore, for example, the user operates the terminal 11 so as to limit the interaction used for constructing the interaction network to predation (eating). Moreover, for example, in the construction of the interaction network, the user operates the terminal 11 so as to limit the main biological species and the sub-biological species targeted for the interaction search to the biological species constituting the combination of the biological species targeted for the construction of the interaction network and the introduced algae.

The restriction information generation unit 81 (FIG. 11) generates the restriction information according to the operation of the terminal 11.

In the decision unit 52, a combination of related animal species is generated by selecting the relevant animal species from the biological species list. Moreover, the decision unit 52 generates an additional combination by adding the observed animal species registered in the additional list to the combination of the related animal species generated from the biological species list.

Then, in the decision unit 52, an interaction network is constructed for the additional combination by using the interaction information. The construction of the interaction network is performed by limiting the main biological species and the sub-biological species to be searched for the interaction and the interaction used for the construction of the interaction network according to the restriction information.

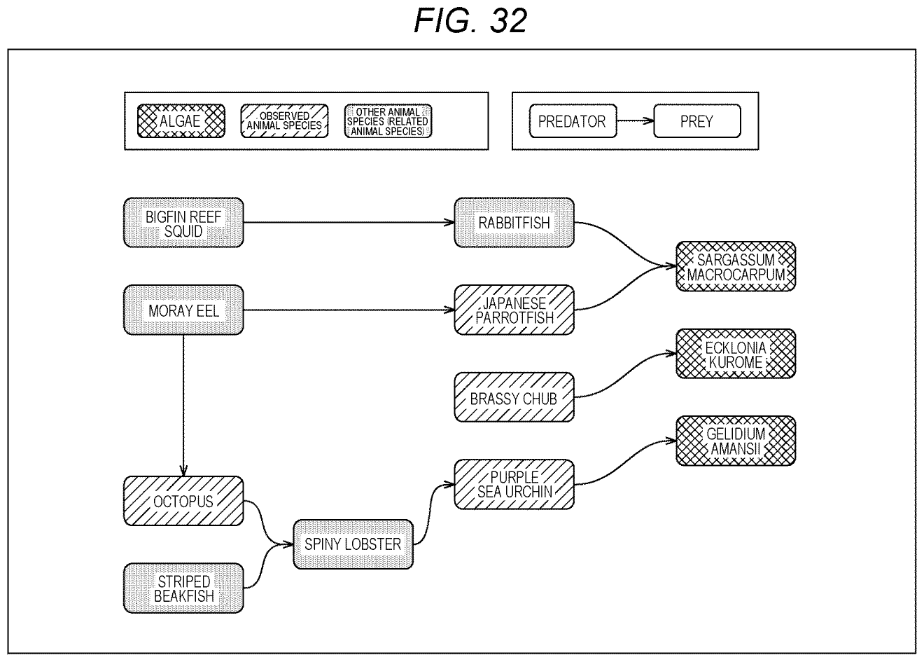

FIG. 32 is a diagram illustrating an interaction network generated for an additional combination obtained by adding an observed animal species of Japanese parrotfish, brassy chub, purple sea urchin, and octopus to a combination of related biological species of bigfin reef squid, rabbitfish, moray eel, spiny lobster, and striped beakfish.

In the decision unit 52, by using the interaction information of FIG. 31, a sub-biological species that causes a predation (prey) interaction with each of the related animal species of bigfin reef squid, rabbitfish, moray eel, spiny lobster, and striped beakfish (shaded portion in the drawing) as the main biological species constituting the additional combination, and the observed animal species of Japanese parrotfish, brassy chub, purple sea urchin, and octopus (shaded portion in the drawing) is searched for.

In FIG. 32, for example, regarding a related animal species moray eel as a main biological species, an observed animal species of Japanese parrotfish which the moray eel preys on is searched for as a sub-biological species. Furthermore, for example, regarding the observed animal species Japanese parrotfish as the main biological species, introduced algae Sargassum macrocarpum which the Japanese parrotfish feeds on has been searched for as a sub-biological species.

The main biological species constituting the additive combination and the sub-biological species (biological species preyed on by the main biological species) causing a predatory interaction with the main biological species become nodes of an interaction network for the additional combination.

In the decision unit 52, after searching for the sub-biological species that cause an interaction with each of the main biological species, an interaction of predation occurring between any two biological species among all the biological species of the main biological species and the sub-biological species is searched for using the interaction information of FIG. 31.

In the decision unit 52, nodes that cause a predation interaction among nodes of the biological species (main biological species and sub-biological species) are connected by arrows as links, thereby constructing an interaction network.

In an interaction network, a node of a predator (predatory biological species) and a node of a prey (predated biological species) are connected by an arrow in a direction from the node of the predator toward the node of the prey as a link representing a predatory interaction.

For example, an arrow as a link representing an interaction in which the observed animal species of Japanese parrotfish preys (feeds) on the introduced algae Sargassum macrocarpum is an arrow in a direction having a node of Japanese parrotfish as a predator as a start point and a node of Sargassum macrocarpum as a prey as an end point.

In order to improve the efficiency of the fixation of the introduced algae, the user operates the terminal 11 so that the smaller the chance of the introduced algae being preyed on, the higher the evaluation. The evaluation method information generation unit 42 generates the evaluation method information according to the operation of the terminal 11.

In the decision unit 52, the calculation formula of the evaluation score is set as, for example, Formula (2) according to the evaluation method information.

$$Evaluation score = \sum Predation suppression score \qquad ( 2 )$$

The predation suppression score represents the degree to which the predation of the introduced algae is suppressed, and is calculated for each biological species other than the introduced algae serving as a node of the interaction network. In Formula (2), Σ represents the summation of the predation suppression score for all biological species other than the introduced algae.

After constructing the interaction network, the decision unit 52 evaluates the interaction network. The evaluation of the interaction network is performed by calculating an evaluation score according to the calculation formula of Formula (2) set according to the evaluation method information.

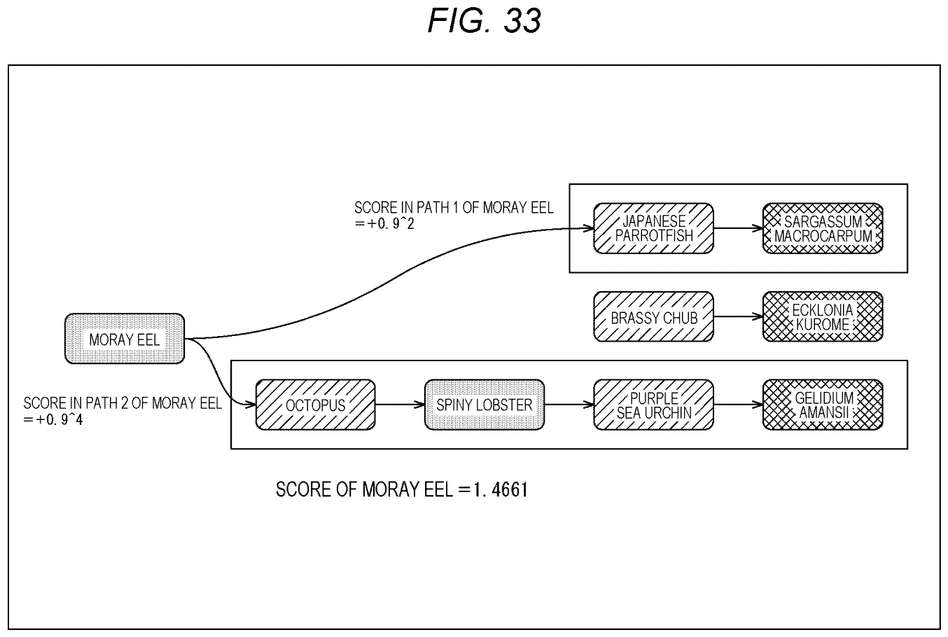

FIG. 33 is a diagram illustrating an interaction network generated for an additional combination obtained by adding an observed animal species of Japanese parrotfish, brassy chub, purple sea urchin, and octopus to a combination of related biological species of moray eels and spiny lobsters.

In a case of calculating the predation suppression score of the calculation formula of Formula (2), the decision unit 52 specifies the introduced algae from (the biological species serving as a node of) the interaction network.

For the interaction network of FIG. 33, Sargassum macrocarpum, Ecklonia kurome, and Gelidium amansii are specified as introduced algae.

In the interaction network, for each biological species other than the introduced algae, the decision unit 52 searches for a path that moves in the direction of the arrow representing the link with the node of the biological species as a start point and reaches the node of the introduced algae as an interaction path that affects the predation of the introduced algae.

That is, the decision unit 52 searches for, as an interaction path, a path that does not pass through the same node a plurality of times with a node of a biological species other than the introduced algae as a start point and any node of the introduced algae as an end point.

In the interaction network of FIG. 33, for example, for a moray eel, an interaction path that leads from the node of the moray eel to the node of the introduced algal Sargassum macrocarpum via the Japanese parrotfish is searched. Moreover, as for the moray eel, an interaction path that leads from the node of the moray eel to the node of the introduced algae Gelidium amansii via the octopus, the spiny lobster, and the purple sea urchin is searched.

Furthermore, for example, for Japanese parrotfish, an interaction path that directly reaches the node of the introduced algal Sargassum macrocarpum from the node of the Japanese parrotfish is searched.

The decision unit 52 calculates the predation suppression score according to the number L of links from the biological species at the start point to reaching the introduced algae at the end point in each interaction path for each biological species other than the introduced algae.

That is, the decision unit 52 calculates the predation suppression score of the interaction path according to, for example, Formula (3).

$$Predation suppression score of interaction path = SGN \times 0.9 \hat{} L \qquad ( 3 )$$

In Formula (3), SGN represents −1 in a case where the number L of links is an odd number, and +1 in a case where the number L of links is an even number.

According to Formula (3), a value indicating the degree to which the biological species at the start point of the interaction path contributes to suppression of predation by the introduced algae at the end point or the degree to which the biological species becomes an obstacle is calculated as the predation suppression score.

In a case where the biological species at the start point of the interaction path contributes to the suppression of the predation of the introduced algae at the end point, that is, a case where the predation of the introduced algae is suppressed, the predation suppression score has a positive value. In a case where the biological species at the start point of the interaction path becomes an obstacle to the suppression of the predation of the introduced algae at the end point, that is, a case where the predation of the introduced algae is not suppressed (promoted), the predation suppression score has a negative value.

The decision unit 52 calculates the predation suppression score of each biological species other than the introduced algae by summing the predation suppression scores of the interaction paths for the biological species.

In FIG. 33, for example, with respect to the moray eel, since the number L of links of the interaction path reaching the node of the introduced algae Sargassum macrocarpum starting from the node of the moray eel is 2, +0.9\hat{ }2 is calculated as the predation suppression score of the interaction path.

Moreover, for the moray eel, since the number of links of the interaction path reaching the node of the introduced algae Gelidium amansii starting from the node of the moray eel is 4, +0.9\hat{ }4 is calculated as the predation suppression score of the interaction path.

Then, as the predation suppression score of the moray eel, 1.4661=+0.9\hat{ }2++0.9\hat{ }4 obtained by adding the predation suppression scores of the above-described two interaction paths is calculated.

For the interaction network of FIG. 33, the predation suppression score of each biological species other than the introduced algae is calculated in a similar manner hereinafter.

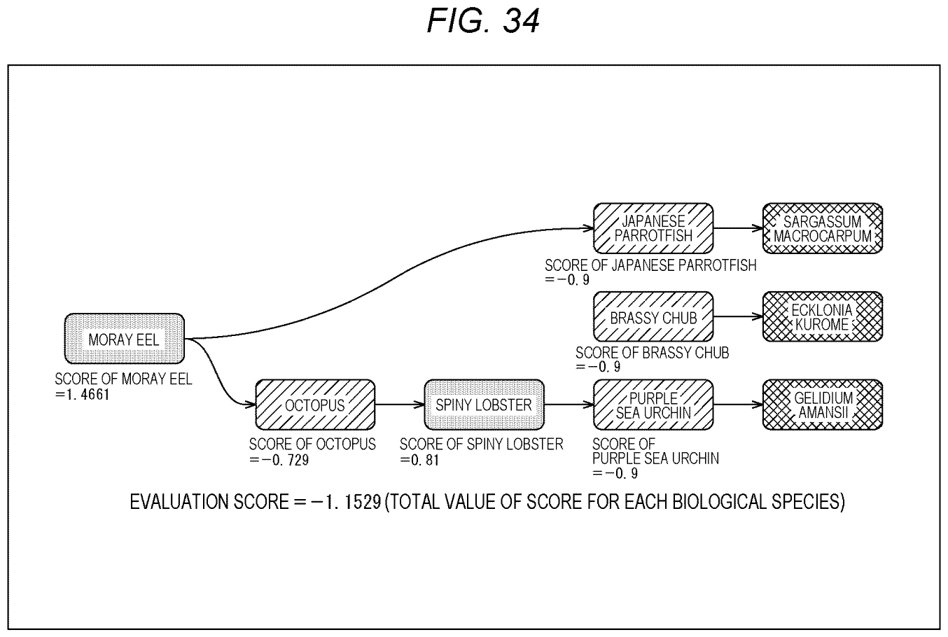

FIG. 34 is a diagram illustrating a calculation result of the predation suppression score.

That is, FIG. 34 illustrates a calculation result of the predation suppression score of each biological species other than the introduced algae in the interaction network of FIG. 33.

As the evaluation score of the interaction network in FIG. 33, a total of −1.1529 of the respective predation suppression scores of the biological species of moray eel, spiny lobster, Japanese parrotfish, brassy chub, purple sea urchin, and octopus other than the introduced algae is calculated.

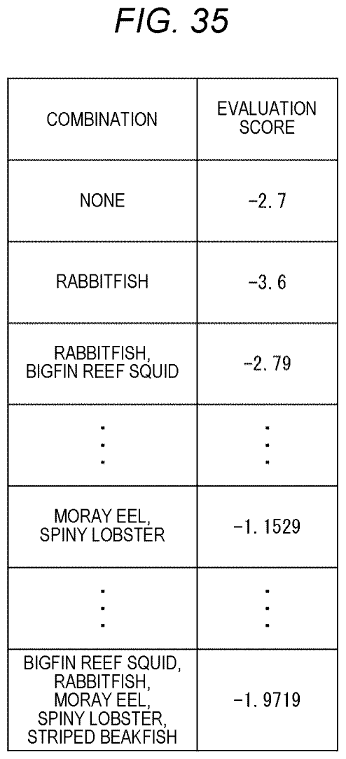

FIG. 35 is a diagram illustrating evaluation scores of an interaction network for additional combinations obtained by adding an observed animal species registered in the additional list to all combinations of 0 or more related animal species generated from the biological species list.

That is, FIG. 35 illustrates the evaluation scores of the interaction network for the additional combinations obtained by adding Japanese parrotfish, brassy chub, purple sea urchin, and octopus registered in the additional list to all combinations of 0 or more related animal species generated from the biological species list in which bigfin reef squids, rabbitfish, moray eels, spiny lobsters, and striped beakfish are registered.

Note that, in FIG. 35, “combination” represents a combination of 0 or more related animal species generated from the biological species list.

In FIG. 35, for example, the first evaluation score (from the top) represents the evaluation score of the interaction network for an additional combination obtained by adding Japanese parrotfish, brassy chub, purple sea urchin, and octopus registered in the additional list to a combination of 0 related animal species (combination of empty sets).

Furthermore, for example, the second evaluation score represents an evaluation score of an interaction network for an additional combination obtained by adding Japanese parrotfish, brassy chub, purple sea urchin, and octopus registered in the additional list to a combination of only the related animal species rabbitfish. Moreover, for example, the third evaluation score represents an evaluation score of an interaction network for an additional combination obtained by adding Japanese parrotfish, brassy chub, purple sea urchin, and octopus registered in the additional list to a combination of the related animal species rabbitfish and bigfin reef squid.

The decision unit 52 decides the combination having the best evaluation score of the interaction network as the presentation combination.

In FIG. 35, the interaction network has the best evaluation score of −1.1529 for the additional combination obtained by adding Japanese parrotfish, brassy chub, purple sea urchin, and octopus registered in the additional list to the combination of the related animal species moray eels and spiny lobsters. Therefore, the combination of the related animal species moray eels and spiny lobsters having the best evaluation score, or the additional combination obtained by adding Japanese parrotfish, brassy chub, purple sea urchin, and octopus registered in the additional list to the combination is decided as the presentation combination. With the presentation of this presentation combination, the user can recognize that, in a case where marine algae such as Sargassum macrocarpum, Ecklonia kurome, and Gelidium amansii are introduced into a marine area in which Japanese parrotfish, brassy chub, purple sea urchin, and octopus are observed, in order to improve the efficiency of fixing of these marine algae, moray eels and spiny lobsters should be introduced.

Note that the embodiments of the present technology are not limited to the above-described embodiments, and various changes can be made without departing from the gist of the present technology.

As an embodiment of the present technology, in addition to the above-described embodiments, in each embodiment, a mode in which components of other embodiments are combined can be employed as much as possible.

For example, the processing using the additional list in FIG. 18 can be combined with the processing of converting the common name of the biological species into the scientific name using the biological species name information in step S123 in FIG. 20. In this case, in addition to the common name of the biological species registered in the biological species list, the common name of the biological species registered in the additional list is also converted into a scientific name using the biological species name information.

Furthermore, for example, the processing using the additional list in FIG. 18 can be combined with determination of a presentation combination by solving a combination optimization problem by an approximate solution as described with reference to FIGS. 25 and 26.

The present technology may be configured as cloud computing in which one function is shared by a plurality of devices through the network to process together.

Each step of the processing of the terminal 11 and the server 12 can be executed by one device or can be shared and executed by a plurality of devices.

In a case where a plurality of processes is included in one step, the plurality of processes included in the one step can be executed by one device or can be shared and executed by a plurality of devices.

Furthermore, the effects described herein are merely examples and are not limited, and other effects may be provided.

Note that the present technology can be configured as follows.

<1>

A program for causing a computer to function as:
a decision unit that constructs, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, the decision unit deciding a presentation combination that is a combination of biological species to be presented according to evaluation of the interaction network obtained by evaluating the interaction network by an evaluation method regarding an ecosystem.

<2>

The program according to <1>, in which
the decision unit restricts the main biological species, the sub-biological species, or both the main biological species and the sub-biological species.

<3>

The program according to <1> or <2>, in which
the decision unit sets the evaluation method according to an input from outside.

<4>

The program according to any one of <1> to <3>, further including
a ranking unit that ranks the main biological species constituting the presentation combination according to the interaction network for the presentation combination.

<5>

The program according to any one of <1> to <4>, further including
a generation unit that generates a presentation user interface (UI) that presents the presentation combination.

<6>

The program according to <5>, in which
the decision unit reconstructs the interaction network for the presentation combination after an operation according to an operation on the presentation combination presented in the presentation UI, and
the presentation UI presents the interaction network after reconstruction.

<7>

The program according to any one of <1> to <6>, in which
the plurality of biological species is a plurality of biological species actually existing in a predetermined place.

<8>

The program according to any one of <1> to <7>, in which
the decision unit decides the presentation combination according to evaluation of the interaction network constructed for a combination obtained by adding a predetermined biological species to a combination of biological species selected from the plurality of biological species.

<9>

The program according to any one of <1> to <8>, in which
the plurality of biological species is biological species observed at a place where a predetermined terminal is located.

<10>

The program according to any one of <1> to <9>, in which
the decision unit constructs the interaction network with reference to a database of interaction information, and
the database is updated according to an input from a user.

<11>

The program according to any one of <1> to <10>, in which
the decision unit decides a combination of biological species having a best score obtained by evaluation of the interaction network as the presentation combination.

<12>

The program according to any one of <1> to <11>, in which
information of the plurality of biological species transmitted from a predetermined terminal is received.

<13>

The program according to <12>, in which
a presentation UI that presents the presentation combination is transmitted to the terminal.

<14>

The program according to any one of <1> to <13>, in which
the decision unit constructs the interaction network for each of a plurality of combinations of plant species selected from a plurality of plant species using a plant species as the main biological species and a microbial species as the sub-biological species as nodes, and decides the presentation combination according to the evaluation of the interaction network.

<15>

The program according to <14>, in which
the decision unit evaluates the interaction network by the evaluation method that gives a higher evaluation as species diversity of the plant species is higher, the evaluation method that gives a lower evaluation as an infection risk of pathogenic microorganisms is higher, or the evaluation method that gives a higher evaluation to that species diversity of the microbial species is improved.

<16>

The program according to <15>, in which
the decision unit calculates a plant species diversity score representing species diversity of the plant species or an influence degree score representing a degree of influence of the plant species on the infection risk of the pathogenic microorganism in the evaluation of the interaction network.

<17>

The program according to any one of <1> to <16>, further including
an acquisition unit that acquires information of the plurality of biological species.

<18>

An information processing device, including
a decision unit that constructs, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, the decision unit deciding a presentation combination that is a combination of biological species to be presented according to evaluation of the interaction network obtained by evaluating the interaction network by an evaluation method regarding an ecosystem.

<19>

An information processing method, including
constructing, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, and deciding a presentation combination that is a combination of biological species to be presented according to evaluation of the interaction network obtained by evaluating the interaction network by an evaluation method regarding an ecosystem.

<20>

A program for causing a computer to function as:
a transmission unit that transmits information of a plurality of biological species to an information processing device; and
a display control unit that causes a display unit to display a presentation UI that presents a presentation combination obtained by
the information processing device constructing, for each of a plurality of combinations of biological species selected from the plurality of biological species, an interaction network representing an interaction between a main biological species and a sub-biological species using the main biological species that is a biological species constituting the combination and the sub-biological species that is another biological species that causes an interaction with the main biological species as nodes, and deciding a presentation combination that is a combination of biological species to be presented according to evaluation of the interaction network obtained by evaluating the interaction network by an evaluation method regarding an ecosystem.

### REFERENCE SIGNS LIST

10 Information processing system
11-1 to 11-4 Terminal
12 Server
13 Database
14 Network
21 Communication unit
22 Calculation unit
23 Input-output unit
24 Storage
25 Positioning unit
31 Communication unit
32 Calculation unit
33 Input-output unit
34 Storage
41 Biological species list generation unit
42 Evaluation method information generation unit
43 Transmission unit
44 Reception unit
45 Display control unit
46 Display unit
51 Reception unit
52 Decision unit
53 Generation unit
54 Transmission unit
71 Combination generation unit
72 Network construction unit
73 Evaluation unit
74 Selection unit
81 Restriction information generation unit
91 Combination generation unit
92 Network construction unit
111 Ranking unit
131 Combination generation unit
133 Evaluation unit
134 Determination unit

1. A program for causing a computer to function as:
a decision unit that constructs, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, the decision unit deciding a presentation combination that is a combination of biological species to be presented according to evaluation of the interaction network obtained by evaluating the interaction network by an evaluation method regarding an ecosystem.

2. The program according to claim 1, wherein
the decision unit restricts the main biological species, the sub-biological species, or both the main biological species and the sub-biological species.

3. The program according to claim 1, wherein
the decision unit sets the evaluation method according to an input from outside.

4. The program according to claim 1, further comprising
a ranking unit that ranks the main biological species constituting the presentation combination according to the interaction network for the presentation combination.

5. The program according to claim 1, further comprising
a generation unit that generates a presentation user interface (UI) that presents the presentation combination.

6. The program according to claim 5, wherein
the decision unit reconstructs the interaction network for the presentation combination after an operation according to an operation on the presentation combination presented in the presentation UI, and
the presentation UI presents the interaction network after reconstruction.

7. The program according to claim 1, wherein
the plurality of biological species is a plurality of biological species actually existing in a predetermined place.

8. The program according to claim 1, wherein
the decision unit decides the presentation combination according to evaluation of the interaction network constructed for a combination obtained by adding a predetermined biological species to a combination of biological species selected from the plurality of biological species.

9. The program according to claim 1, wherein
the plurality of biological species is biological species observed at a place where a predetermined terminal is located.

10. The program according to claim 1, wherein
the decision unit constructs the interaction network with reference to a database of interaction information, and
the database is updated according to an input from a user.

11. The program according to claim 1, wherein
the decision unit decides a combination of biological species having a best score obtained by evaluation of the interaction network as the presentation combination.

12. The program according to claim 1, wherein
information of the plurality of biological species transmitted from a predetermined terminal is received.

13. The program according to claim 12, wherein
a presentation UI that presents the presentation combination is transmitted to the terminal.

14. The program according to claim 1, wherein
the decision unit constructs the interaction network for each of a plurality of combinations of plant species selected from a plurality of plant species using a plant species as the main biological species and a microbial species as the sub-biological species as nodes, and decides the presentation combination according to the evaluation of the interaction network.

15. The program according to claim 14, wherein
the decision unit evaluates the interaction network by the evaluation method that gives a higher evaluation as species diversity of the plant species is higher, the evaluation method that gives a lower evaluation as an infection risk of pathogenic microorganisms is higher, or the evaluation method that gives a higher evaluation to that species diversity of the microbial species is improved.

16. The program according to claim 15, wherein
the decision unit calculates a plant species diversity score representing species diversity of the plant species or an influence degree score representing a degree of influence of the plant species on the infection risk of the pathogenic microorganism in the evaluation of the interaction network.

17. The program according to claim 1, further comprising
an acquisition unit that acquires information of the plurality of biological species.

18. An information processing device, comprising
a decision unit that constructs, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, the decision unit deciding a presentation combination that is a combination of biological species to be presented according to evaluation of the interaction network obtained by evaluating the interaction network by an evaluation method regarding an ecosystem.

19. An information processing method, comprising
constructing, for each of a plurality of combinations of biological species selected from a plurality of biological species, an interaction network representing an interaction between a main biological species and a sub-biological species using the main biological species that is a biological species constituting the combination and the sub-biological species that is another biological species that causes an interaction with the main biological species as nodes, and deciding a presentation combination that is a combination of biological species to be presented according to evaluation of the interaction network obtained by evaluating the interaction network by an evaluation method regarding an ecosystem.

20. A program for causing a computer to function as:
a transmission unit that transmits information of a plurality of biological species to an information processing device; and
a display control unit that causes a display unit to display a presentation UI that presents a presentation combination obtained by
the information processing device constructing, for each of a plurality of combinations of biological species selected from the plurality of biological species, an interaction network representing an interaction between a main biological species and a sub-biological species using the main biological species that is a biological species constituting the combination and the sub-biological species that is another biological species that causes an interaction with the main biological species as nodes, and deciding a presentation combination that is a combination of biological species to be presented according to evaluation of the interaction network obtained by evaluating the interaction network by an evaluation method regarding an ecosystem.
